(19) United States
(12) Patent Application Publication
(10) Pub. No.: US 2022/0341247 A1
(43) Pub. Date: Oct. 27, 2022

(54) AUTOMATIC DOOR PASSAGE ASSISTANCE APPARATUS, PASSAGE ASSISTANCE METHOD, PROGRAM, AND RECORDING MEDIUM

(71) Applicants: NEC Solution Innovators, Ltd., Tokyo (JP); FulltechINC., Sapporo-shi, Hokkaido (JP)

(72) Inventors: Kenji KISHIOKA, Koto-ku, Tokyo (JP); Tatsuya NAKAGAWA, Sapporo-shi, Hokkaido (JP); Yoshinobu KOSEKI, Sapporo-shi,Hokkaido (JP); Yusuke MIYANOHARA, Tokyo (JP); Yoshihiro ICHIDA, Sapporo-shi,Hokkaido (JP); Motoaki FURUNO, Sapporo-shi, Hokkaido (JP); Tatsuru MISAWA, Sapporo-shi, Hokkaido (JP)

(73) Assignees: NEC Solution Innovators, Ltd., Tokyo (JP); FulltechINC., Sapporo-shi, Hokkaido (JP)

(21) Appl. No.: 17/642,569

(22) PCT Filed: Sep. 11, 2020
(86) PCT No.: PCT/JP2020/034548

§ 371 Date: Mar. 11, 2022

(30) Foreign Application Priority Data
Sep. 13, 2019 (JP) 2019-167588

(51) Int. Cl. E05F 15/73

(52) U.S. Cl. CPC E05F 15/73; E05F 2015/767

(57) ABSTRACT

In a passage assistance apparatus (1) according to the present invention, a storage unit (10) stores passage assistance information regarding passage through an automatic door, a passage condition regarding passage through the automatic door and information regarding an attribute of an image of the surrounding region of the automatic door are associated with each other in the passage assistance information. The passage condition is at least one of the automatic door opening/closing condition and a passage guide condition for the automatic door user, an image acquisition unit (11) acquires a real time image of the surrounding region of the automatic door, an identification unit (12) identifies attribute information, with respect to the real time image, a passage condition selection unit (13) selects a passage condition associated with attribute information in the storage unit (10) that has matched the identified attribute information, and an output unit (14) outputs the selected passage condition.

### TECHNICAL FIELD

The present invention relates to an automatic door passage assistance apparatus, a passage assistance method, a program, and a recording medium.

### BACKGROUND ART

Automatic doors installed in entrances of buildings or the like usually are configured to detect people with human detecting sensors such as infrared sensors and are opened and closed automatically (Patent literature 1).

### CITATION LIST

### Patent Literature

Patent literature 1: JP 2002-285755 A

### SUMMARY OF INVENTION

### Technical Problem

However, with regard to the current automatic doors, there are issues that passing persons collide with automatic doors, automatic doors open when the doors do not need to open, and congestion occurs, for example. Further, in addition to this, it is desired to provide assistance to people who need some kind of assistance for passage and to make improvement regarding suppression of accidents caused by collisions with passing persons, for example.

In view of this, the present invention aims to provide a new device that enables safe and smooth passage according to the condition of an automatic door user, and the condition of the surrounding region of the automatic door, for example.

### Solution to Problem

In order to achieve the aim, an automatic door passage assistance apparatus according to the present invention includes:

a storage unit;

an image acquisition unit;

an identification unit;

a passage condition selection unit; and

an output unit,

in which the storage unit is configured to store passage assistance information regarding passage through an automatic door,

a passage condition regarding passage through the automatic door and information regarding an attribute of an image of a surrounding region of the automatic door are associated with each other in the passage assistance information,

the passage condition is at least one of an automatic door opening/closing condition and a passage guide condition for an automatic door user,

the image acquisition unit is configured to acquire a real time image of the surrounding region of the automatic door,

the identification unit is configured to identify the attribute information, with respect to the real time image,

the passage condition selection unit is configured to select a passage condition associated with the attribute information in the storage unit that has matched the identified attribute information, and

the output unit is configured to output the selected passage condition.

An automatic door passage assistance method according to the present invention includes,

an image acquisition step;

an identification step;

a passage condition selection step; and

an output step,

wherein passage assistance information regarding passage through an automatic door stored in a storage unit is used,

a passage condition regarding passage through the automatic door and information regarding an attribute of an image of a surrounding region of the automatic door are associated with each other in the passage assistance information,

the passage condition is at least one of an automatic door opening/closing condition and a passage guide condition for an automatic door user,

in the image acquisition step, a real time image of a surrounding region of the automatic door is acquired,

in the identification step, the attribute information is identified, with respect to the real time image;

in the passage condition selection step, a passage condition associated with attribute information in the storage unit that has matched the identified attribute information is selected; and

in the output step, the selected passage condition is output.

A program according to the present invention causes a computer to execute the steps of the automatic door passage assistance method according to the present invention as a procedure.

A recording medium according to the present invention is computer readable medium on which the program according to the present invention is recorded.

### Advantageous Effects of Invention

According to the present invention, it is possible to control opening/closing of an automatic door and output guide conditions for a user, using images of a surrounding region of the automatic door, according to the user of the automatic door and the condition of the surrounding region of the automatic door, for example. Accordingly, it is possible to ensure the safety of passing persons and allow smooth passage while suppressing the occurrence of waiting time, congestion, and the like when passing through the automatic door, for example.

### BRIEF DESCRIPTION OF DRAWINGS

FIG. 1 is a block diagram showing an example of a passage assistance apparatus according to Embodiment 1.

FIG. 2 is a block diagram showing another example of the passage assistance apparatus according to Embodiment 1.

FIG. 3 is a block diagram showing an example of a hardware configuration of the passage assistance apparatus according to Embodiment 1.

FIG. 4 is a flowchart showing an example of a passage assistance method according to Embodiment 5.

FIG. 5 is a diagram showing an example of region information.

FIG. 6 is a diagram showing an example of processing performed by a specific motion detection unit if specific operation information is information regarding a passing-by motion.

FIG. 7 is a diagram showing an example for detecting the end of a specific motion of a moving object.

FIG. 8 is a flowchart showing an example for detecting a passing-by motion and controlling opening/closing of an automatic door in a passage assistance method according to Embodiment 4.

### DESCRIPTION OF EMBODIMENTS

In the present invention, there is no particular limitation on an automatic door to be controlled, and the automatic door may be a door that is automatically opened and closed when a person comes and goes instead of being opened and closed by the person. There is no particular limitation on the place where the automatic door is installed, and the automatic doors may be doors for entrances and exits of facilities such as office buildings, commercial buildings, and hotels, elevator doors, flapper gates used for entering and exiting rooms, ticket gates (platform doors) for railways and the like, and doors for public transportation vehicles (e.g., electric railcars and buses), for example. In the present invention, the users of automatic doors mean persons who pass through the automatic doors.

Automatic doors are usually used for persons to enter and exit. In the present invention, an automatic door to be controlled may function as the entrance for passage only in one direction, function as the exit for passage in the other directions, or function as the entrance and the exit for bidirectional passage for the entrance and exit, for example. Also, the terms “entrance”, “exit”, “entering direction”, “exiting direction” and the like are used in the following embodiments, and these terms are defined for convenience. In the present invention, there is no limitation on whether the automatic door is the entrance for entering the inside from the outside or the exit for exiting from the inside to the outside.

Embodiment 1

Examples of an automatic door passage assistance apparatus according to the present invention and a passage assistance method according to the present invention will be described using the drawings.

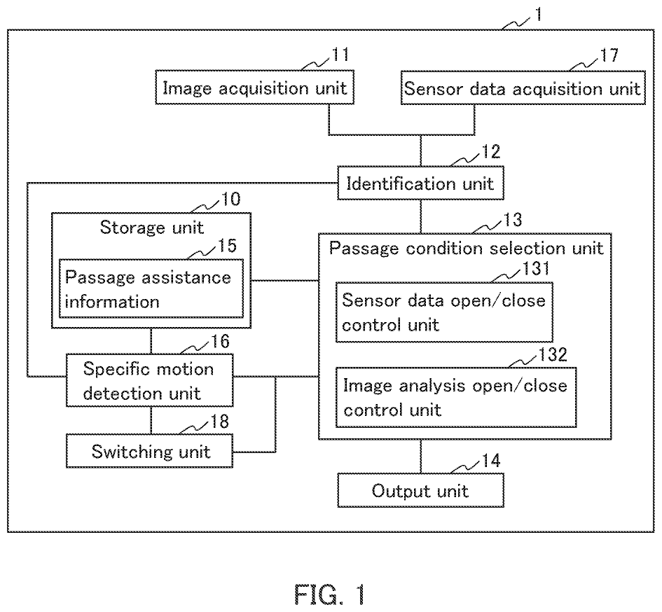

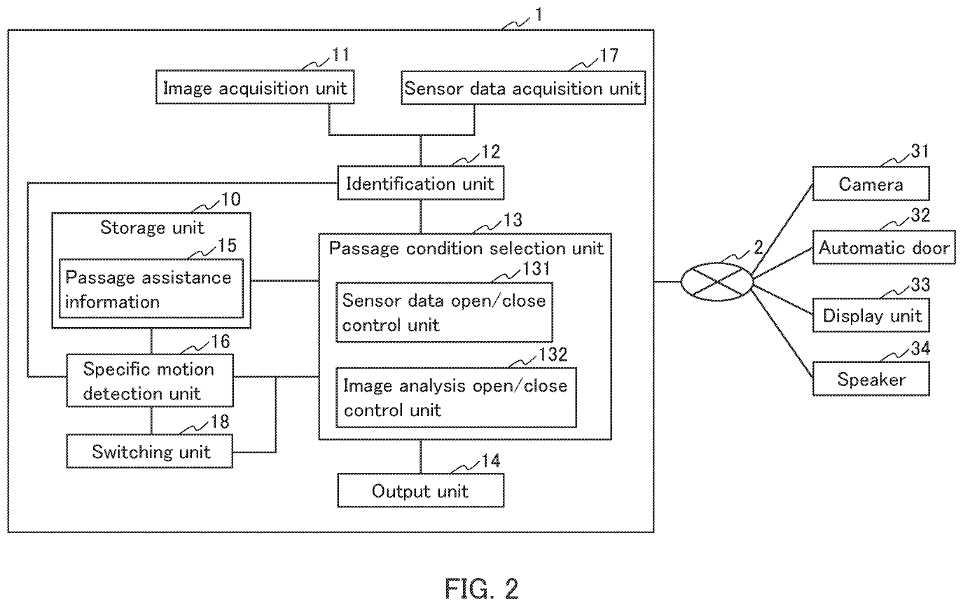

FIG. 1 is a block diagram showing an example of a passage assistance apparatus according to this embodiment. The passage assistance apparatus 1 includes a storage unit 10, an image acquisition unit 11, an identification unit 12, a passage condition selection unit 13, and an output unit 14. The storage unit 10 includes the passage assistance information 15. The passage assistance apparatus 1 is also referred to as a “passage assistance system”, for example. The passage assistance apparatus 1 may be one apparatus that includes the units, or the units may be apparatuses that are connectable to each other via a communication network, for example. As shown in FIG. 2, the passage assistance apparatus 1 may be connectable to a camera 31, an automatic door 32, a display unit 33, a speaker 34, and the like via a communication network 2, for example. The passage assistance system may include the passage assistance apparatus 1, and optionally include the automatic door 32, the display unit 33, and the speaker 34, for example. These modes will be described later as appropriate.

The passage assistance apparatus 1 may also be incorporated in a server as a system, for example. Also, this apparatus 1 may be a personal computer (PC such as a desktop computer or laptop computer) in which a program according to the present invention is installed, a terminal (a smartphone or tablet terminal), or the like, for example. Furthermore, this apparatus 1 may be in the form of cloud computing, edge computing, or the like, for example, such that at least one of the units is located on a server and the other units are located on a terminal.

The storage unit 10 stores passage assistance information 15, and a passage condition regarding passage through the automatic door and information regarding attributes of images of a surrounding region of the automatic door are associated with each other in the passage assistance information 15.

The passage condition is at least one of an automatic door opening/closing condition and a passage guide condition for an automatic door user, and either one may be used, but both are preferable.

Examples of the automatic door opening/closing condition include opening of the automatic door, closing of the automatic door, opening timing, closing timing, opening speed, closing speed, opening holding time, and opening width. Furthermore, the passage guide condition includes announcement content (guide information) for automatic door users at the time of passage, and examples thereof include an announcement on the passing side, an announcement about caution, and an announcement at the entrance or exit of the automatic door.

Examples of the image attribute information in the passage assistance information 15 in the storage unit 10 include information regarding an attribute of a moving object in an image and information regarding a movement of a moving object in an image, and either one of the pieces of information may be used, but it is preferable to use both of the pieces of information.

Examples of the moving object attribute information include information regarding whether or not the moving object is a person, an age group, the presence or absence of an accessory, the number of people, gender, nationality, and considerations regarding passage. “Whether or not the moving object is a person” indicates the classification of a human and an object other than a human, that is, a human and an animal other than a human (dog, cat, etc.), for example. There is no particular limitation on “age group”, and examples thereof include the age, an age range, groups indicated by the age range (e.g., infants, children, elementary school students, middle and high school students, adults, elderly people, etc.). The “presence or absence of an accessory” refers to whether an accessory is possessed, and there is no particular limitation on the accessory, and examples thereof include accessories that a human possesses when walking, such as luggage and mobile accessory equipment. Examples of luggage include baby carriages, suitcases, and carry bags. Examples of the mobile accessory equipment include equipment that is possessed for walking, and specific examples thereof include a walking assistive cane, a walker, a rollator, and a wheelchair. Examples of the walking assistive cane include white canes for visually impaired persons, walking canes for physically impaired persons and elderly people, and crutches for injured persons. The “number of people” refers to the number of people in an image, for example, and if an image includes a plurality of persons, information regarding the distance between moving objects (persons) may be included. Examples of “gender” include male and female. The “nationality” may be a country name such as Japan, a region such as Asia, a language region such as an English-speaking country, or a classification as to whether or not a person is a resident of that country, for example. “Passage consideration information” includes information regarding a person who needs some kind of aids for passage, and specific examples thereof include attributes of a person who needs consideration for passage, such as a wheelchair or a person accompanying a child. Also, “passage consideration information” may be a classification regarding whether or not consideration is required for passage, and may be a classification indicating the degree and type of consideration, for example. Furthermore, in the identification of the real time image by the identification unit 12, which will be described later, the moving object information may be directly identified from the real time image or may be identified from a combination of a plurality of attributes identified from the real time image, for example.

Examples of the “moving object movement information” include movement speed and vector information (movement direction, face orientation, eye line, etc.). “Movement speed” refers to the speed at which a person moves in a traveling direction, and also includes the meaning of whether or not the person is moving, for example. “Movement direction” refers to a traveling direction in which a person moves, and specifically, is information regarding whether or not an automatic door to be opened/closed is present forward or in the vicinity in the traveling direction, for example. Also, “movement direction” may be an entering angle with respect to an automatic door, for example. “Face orientation” refers to the orientation of a person's face, that is, the orientation of the line of sight, for example and specifically, information regarding whether or not an automatic door to be opened/closed is present forward or in the vicinity of the line of sight, for example. An “eye line” refers to the looking direction of person's eyes, the focal direction of person's eyes, or the like, and specifically, can be expressed by the distance between pupils, for example.

Also, the image attribute information in the passage assistance information 15 stored in the storage unit 10 may be the image, for example, and in this case, when a real time image is identified by the identification unit 12, which will be described later, the former image and a real time image can also be identified by comparing the former image with the real time image, for example. If the image attribute information in the passage assistance information 15 is an image, specific examples thereof include past images of a surrounding region of the automatic door.

As described above, the passage condition and the image attribute information are associated with each other in the passage assistance information 15. Any suitable passage condition can be set for each piece of the image attribute information as the passage condition, for example, and specifically, the passage condition can be set to a passage condition that is suitable for an estimated situation based on the image attribute information. The passage condition is a condition set from the viewpoint of preventing the occurrence of an accident and improving convenience, for example. Specific examples of a combination of the passage condition and the image attribute information will be described later. If the passage condition is specific attribute information after setting any reference condition, for example, the passage condition may be an adjustment condition such that how to change the reference condition.

There is no particular limitation on the passage condition associated with the image attribute information, and the passage condition may be a hypothetical condition obtained through presumption, or may also be any condition set based on past information, for example. Also, as described above, the image attribute information may be the image, for example. In this case, an image (e.g., an image of the surrounding region of the automatic door) that is considered to be suitable for a given passage condition may be stored in the storage unit 10 as the image attribute information, and may be associated with the passage condition. If the announcement “be careful not to slip” to the automatic door user is set as a passage guide condition, for example, an image of a situation where the user may slip, that is, an image where the floor around the automatic door is wet, an image of high heels, etc., may be stored in the storage unit 10 as the image attribute information, and may also be associated with the passage condition of the announcement, as a specific example.

The passage assistance information may be a model produced through training using, as training data, a set of an image of the surrounding region of the automatic door and a passage condition suitable for the state of the image, for example. The “image of the surrounding region of the automatic door” as the image attribute information may be an image of the surrounding region of the automatic door that is an actual target, an image of an environment in which the automatic door is present (i.e., an image of a surrounding region of another automatic door), or an image of an event that may occur in the surrounding region of the automatic door (i.e., an image that does not include the automatic door), for example.

The image acquisition unit 11 acquires a real time image of the surrounding region of the automatic door. With the passage assistance apparatus 1, the image acquisition unit 11 may acquire the real time image as a camera, or the real time image acquired by a camera may be input to the image acquisition unit 11, for example. In the latter case, the passage assistance apparatus 1 can acquire a real time image through connection to the camera, and there is no particular limitation on the connection, and the connection may be wired or wireless connection, for example. As shown in FIG. 2, the passage assistance apparatus 1 and the camera 31 are connectable to each other via the communication network 2, for example. There is no particular limitation on the communication network 2, and a known communication network can be used and the communication network 2 may be wired or wireless, and specifically, examples thereof include the Internet, WWW (World Wide Web), a telephone line, LAN (Local Area Network), WiFi (Wireless Fidelity), Bluetooth (registered trademark), and DTN (Delay Tolerant Networking). The wireless communication may be either in a mode in which each apparatus performs direct communication (Ad Hoc communication) or indirect communication via an access point.

There is no particular limitation on the positions where the cameras 31 that acquire real time images of the surrounding region of the automatic door are installed and the number of cameras 31. If the automatic door is dedicated to the entrance, it is sufficient that the camera 31 is installed at a position where the camera 31 can capture images of the surrounding region on the entrance side, for example. If the automatic door is dedicated to the exit, it is sufficient that the camera 31 is installed at a position where the camera 31 can capture images of the surrounding region on the exit side, for example. If the automatic door is used as the entrance and the exit, or if the automatic door can switch between the door only for entrance and the door only for exit, it is sufficient that the cameras 31 are installed at positions where the cameras 31 can capture images of the surrounding regions on both sides (the entrance side and the exit side) of the automatic door. The cameras 31 may also be installed above the automatic door or on the left and right sides of the automatic door, for example. If signage is disposed in a surrounding region of the automatic door, the camera 31 may also be mounted on the signage, for example.

The real time image is preferably an image captured continuously or discontinuously over time, for example.

The identification unit 12 identifies attribute information, with respect to the real time image. That is, with respect to the real time image, the identification unit 12 identifies attributes of a moving object in the image, the motion of the moving object in the image, or the condition of the surrounding region of the automatic door in the image, for example. With regard to the moving object attributes, the acquired real time image is analyzed to identify whether or not the moving object (object) included in the image is a human, age group, the presence or absence of an accessory, the number of people, gender, and the like, for example. The moving object attributes may be quantified and identified through image analysis, for example. In this case, attribute information stored in the storage unit 10 is also preferably quantified, and can also be compared using numerical values. With regard to the moving object movement information, the acquired real time image is analyzed to identify the movement speed, and vectors (movement direction, face orientation, eye line, etc.) regarding the moving object (object) included in the image, for example. The moving object movement information may be quantified and identified through image analysis, for example. In this case, attribute information stored in the storage unit 10 is also preferably quantified, and can also be compared using numerical values. Also, the acquired real time image is analyzed to identify the condition of the surrounding region of the automatic door in the images, such as information regarding an object other than a human, for example, a puddle on the ground.

Regarding the real time image, the moving object attributes may be identified stepwise in the image analysis, for example. As a specific example, if whether a moving object included in the images is a human or an animal other than a human is determined through image analysis and it is determined that the moving object is a human in the image analysis, for example, the age group, the presence or absence of an accessory, the number of people, and gender, and the like are further determined, for example. Furthermore, the accessory forms a single body with the human, and thus, the determination of the presence or absence of the accessory also serves as the determination of whether or not the moving object included in the image is a human, for example. If it is determined that the accessory is present in the image, the age group, the number of people, the gender, and the like may also be determined, for example.

In the image analysis, regarding the real time image, the moving object attributes are identified, and then the moving object movement information may also be further identified, for example. The identification unit 12 can identify more accurately the motion of a human, such as the movement speed and the movement direction, using a plurality of the images captured over time, for example.

A commercially available system or artificial intelligence (AI) that performs image analysis can be used for the identification unit 12, for example, and product name Field Analyst (NEC solution innovators, Ltd.) can be used as a specific example, or the like. That is, although the identification unit 12 may be executed by artificial intelligence (AI), there is no limitation to this, for example. By using AI, for example, each piece of information can be identified using one camera, and thus the present invention achieves low costs.

The passage condition selection unit 13 selects a passage condition that is associated with attribute information in the storage unit 10 that has matched the identified attribute information.

The real time image may include a plurality of moving objects. Also, if the automatic door is used for the entrance and the exit, the user moves bidirectionally and passes through the automatic door, and thus, real time images may be acquired at the same time on both the entrance side and the exit side, for example. In such a case, priority may be set in advance for the attribute information, and a passage condition associated to attribute information with high priority may be preferentially selected. Also, as described above, if the automatic door is used for the entrance and the exit, a passage condition that is based on a real time image on either the entrance side and the exit side may be preferentially selected, for example.

Then, the output unit 14 outputs the selected passage condition. Specifically, if the passage condition is the automatic door opening/closing condition, the output unit 14 outputs a control signal corresponding to the opening/closing condition to a control unit of the automatic door that functions to open and close the automatic door. Also, if the passage condition is the passage guide condition, the output unit 14 outputs a signal corresponding to the passage guide condition to the display unit 33, the speaker 34, and the like, for example. An example of the display unit 33 is digital signage provided with the speaker 34, for example. According to the digital signage, the passage guide condition can be presented to the users of the automatic door 32 as sound information or visual information, for example. There is no particular limitation on the location where the digital signage is installed, and the digital signage is installed such that the user who passes through the automatic door 32 can recognize the digital signage, and specifically, the digital signage is installed on or beside the automatic door 32, for example. Furthermore, the digital signage may be directly fixed to the automatic door 32, for example.

Also, as described above, the present invention may be a passage assistance system provided with the passage assistance apparatus 1, the automatic door 32 provided with a control unit that controls opening/closing of the automatic door 32, the display unit 33, and the speaker 34, for example. Also, as shown in FIG. 2, the passage assistance apparatus 1, the automatic door 32, the display unit 33, and the speaker 34 may be connectable to each other via the communication network 2, for example. In this case, the passage assistance information is output from the output unit 14 of the passage assistance apparatus 1 via the communication network 2, and if a signal of the opening/closing condition is input to the automatic door 32, the control unit of the automatic door 32 opens/closes the automatic door 32 according to the signal. Also, if a signal of the passage guide condition is input to the display unit 33 and the speaker 34, the display unit 33 and the speaker 34 present the passage guide condition according to the signal.

The passage guide condition may be any information for the user, and there is no limitation on the type thereof. The form of the passage guide condition may be sound information or visual information, or both sound and visual information, for example. The sound information may be sound (including human voice and synthetic voice), music, alert sound, or a combination thereof, for example. The visual information is information that can be visually perceived, and may be words (letters), symbols, illustrations such as maps, or a combination thereof, for example. There is no particular limitation on the type of language used for the sound information and the visual information, and examples thereof include various languages such as Japanese, English, Spanish, Chinese, and the like. As for the type of language, the language of the passage guide condition can also be selected by identifying the nationality.

If the information regarding the attribute of the moving object in the image is an animal that is not allowed to enter or exit, the passage guide condition may be an alert that prevents the animal from coming close to the automatic door, for example. The alert may be sound, ultrasound, or the like, for example.

The content of the passage guide condition can be set as appropriate according to moving object attribute information and moving object movement information. Specific examples of announcements to ensure safety include “there are people running from the other side. please be careful” and “person accompanying child enters from the other side. please be careful”. Also, examples of announcements regarding the travelling direction include “the elevator is located on your left after moving 50 m forward”. As described above, these announcements may be sound information or visual information, for example.

The destination to which the passage guide condition is output can be set as appropriate according to the type of passage guide condition, for example. In the case of the visual information, the visual information is output to the display unit, and a specific example thereof is signage such as digital signage, for example. The signage is installed in the vicinity of the automatic door, for example. Furthermore, in the case of the sound information, the sound information is output to the speaker, for example. An example of the speaker may be a speaker of the signage, for example. As shown in FIG. 2, the passage assistance apparatus 1 may be connected to the display unit 33 and the speaker 34, and the like via the communication network 2, for example.

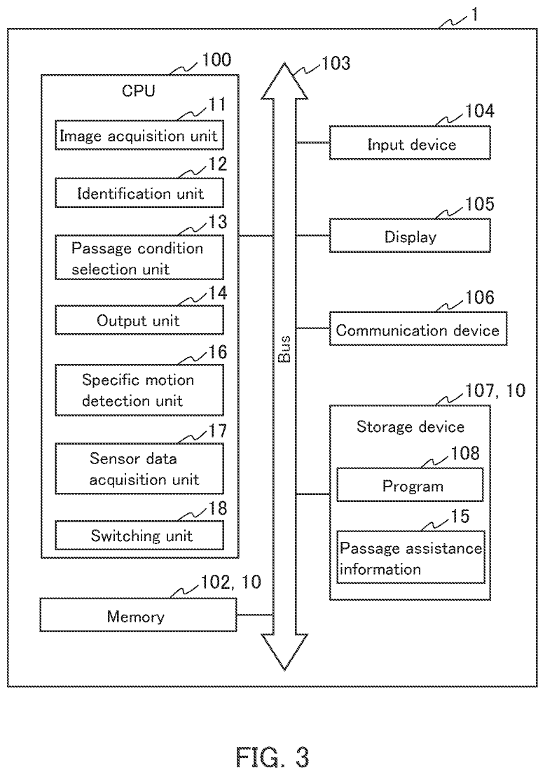

FIG. 3 shows a block diagram of a hardware configuration of the passage assistance apparatus 1. The passage assistance apparatus 1 includes a CPU (Central Processing Unit) 100, a memory 102, a bus 103, an input device 104, a display 105, a communication device 106, a storage device 107, and the like, for example. The units of the passage assistance apparatus 1 are connected to each other via the bus 103 through an interface (I/F), for example.

The CPU 100 is a processor that performs overall control of the passage assistance apparatus 1, and is not limited to a CPU, and may also be another processor. With the passage assistance apparatus 1, a program according to the present invention and other programs are executed by the CPU 100, and various types of information are read and written by the CPU 100, for example. The passage assistance apparatus 1 may also include another central processing unit such as a GPU, instead of the CPU 100. Specifically, the CPU 100 functions as the image acquisition unit 11, the identification unit 12, the passage condition selection unit 13, and the output unit 14, for example.

The passage assistance apparatus 1 is able to connect to the communication network 2 by a communication device 106 connected to the bus 103, and also is able to connect to an external device via the communication network 2, for example. Examples of the external device include the camera 31, the automatic door 32, the display unit 33, the speaker 34, and the like that are described above and shown in FIG. 2, for example. There is no particular limitation on a method for connecting the passage assistance apparatus 1 to the external device, and the connection method may be wired or wireless connection, for example. The wired connection may be a cord connection, a cable connection for using the communication network 2, or the like, for example. The wireless connection may be a connection using the communication network 2, or a connection using wireless communication, for example. There is no particular limitation on the communication network 2, and a known communication network can be used, and the communication network 2 is similar to the above description, for example.

The memory 102 includes a main memory, and the main memory is also referred to as a main storage device, for example. When the CPU 100 performs processing, the memory 102 reads various operation programs 108 that are stored in the later-described auxiliary storage device, such as a program according to the present invention, and the CPU 100 receives data from the memory 102 and executes the program 108, for example. The main memory is a RAM (Random Access Memory), for example. The memory 102 further includes a ROM (Read Only Memory), for example.

The storage device 107 is also referred to as a so-called auxiliary storage device, with respect to the main memory (main storage device), for example. The storage device 107 includes a storage medium and a drive for reading and writing to the storage medium, for example. There is no particular limitation on the storage medium, and the storage medium may be a built-in or external storage medium. Examples thereof include HD (hard disk), CD-ROM, CD-R, CD-RW, MO, DVD, a flash memory, and a memory card, and there is no particular limitation on the drive. An example of the storage device 107 is a hard disk drive (HDD) in which a storage medium and a drive are integrated, for example. As described above, the program 108 is stored in the storage device 107, and as described above, when the CPU 100 is caused to execute the program, the memory 102 reads the operation program 108 from the storage device 107, for example. Furthermore, the passage assistance information 15, images obtained from the camera 31, and information obtained by the passage assistance apparatus 1, and the like may be stored in the storage device 107, for example.

The memory 102 and the storage device 104 can be used for the storage unit 10, for example.

With the passage assistance apparatus 1, user log information and information acquired from an external database (not shown) can be stored in the memory 102 and the storage device 104.

Examples of the input device 104 includes a scanner, a touch panel, a keyboard, and a mouse. Examples of the display 105 includes an LED display, a liquid crystal display, a projector, and signage.

Next, an automatic door passage assistance method according to this embodiment will be described. The passage assistance method according to this embodiment can be implemented using the passage assistance apparatus 1 shown in FIGS. 1 to 3, for example. Note that the passage assistance method according to this embodiment is not limited to use of the passage assistance apparatus 1 shown in these diagrams. Also, a description of the passage assistance method according to this embodiment can be applied to the above-described passage assistance apparatus 1.

The above-described automatic door passage assistance information is used in the passage assistance method according to the present invention. The passage assistance information, which is stored in the storage unit 10 in the passage assistance apparatus 1 according to the present invention, can be used in the passage assistance method according to the present invention, for example. Also, the passage assistance method according to the present invention includes a storing step, for example, and the passage assistance information may be stored in the storing step. The storing step can be executed by the storage unit 10 in the passage assistance apparatus 1, for example.

As described above, the passage assistance method according to the present invention includes an image acquisition step, an identification step, a passage condition selection step, and an output step. The image acquisition step is a step of acquiring a real time image of a surrounding region of an automatic door, and can be executed by the image acquisition unit 11 of the passage assistance apparatus 1, for example.

The identification step is a step of identifying attribute information, with respect to the real time image, and can be executed by the identification unit 12 of the passage assistance apparatus 1, for example. The passage condition selection step is a step of selecting a passage condition associated with the attribute information that has matched the real time image, and the passage condition selection step can be executed by the passage condition selection unit 13 of the passage assistance apparatus 1, for example. The output step is a step of outputting the selected passage condition, and can be executed by the output unit 14 of the passage assistance apparatus 1, for example.

This embodiment will be described below using specific examples. Note that these examples are merely examples, and the present invention is not limited to these examples.

Specific Example A

Example A is an example in which the passage condition is the opening/closing of the automatic door.

(A1) Human or not

When the automatic door is opened/closed through detection performed by a human detecting sensor, a moving object may be detected by the human detecting sensor and the automatic door may open even when an animal other than a human comes close to the automatic door. In this example, it is possible to associate, as the passage assistance information, moving object attribute information “human” with the opening/closing condition “open”, which is a passage condition, and to associate moving object attribute information “animal other than human” with the opening/closing condition “close”, which is a passage condition. In this case, when moving object attribute information is identified as “animal other than human” through image analysis of the acquired real time image, the associated opening/closing condition “close” is selected, and the signal thereof is output to the automatic door. If the automatic door is open, the automatic door is then controlled to be closed, and if the automatic door is close, the automatic door is controlled to be kept closed. Due to such control, when an object moving to the automatic door is a dog or a cat, the automatic door is not opened, and only when the object is a human, the automatic door can be opened, for example.

It is also possible to set a high priority to the moving object attribute information “human” or “animal other than human” depending on purposes, for example. That is, the priority of the moving object attribute information “animal other than human” is set high in a place where it is important to control the entry and exit of animals, and, if “human” and “animal other than human” are identified in the real time image, the opening/closing condition “close” associated with “animal” can be preferentially selected, for example. On the other hand, the priority of the moving object attribute information “human” is set high in a place where priority is given to the passage of human, and, if “human” and “animal other than human” are identified in the real time image, the opening/closing condition “open” associated with “human” can be preferentially selected, for example.

(A2) Child Alone

If there is a child alone who can walk on his own, there is a risk that the child may go out of a building, and the child may try to open the automatic door for play. In this example, it is possible to associate, as the passage assistance information, the age group “child”, which is moving object attribute information, and the opening/closing condition “close”, which is a passage condition. In this case, if moving object attribute information is identified as “child” through image analysis of the acquired real time image, the associated opening/closing condition “close” is selected, and the signal thereof is output to the automatic door. If the automatic door is open, the automatic door is then controlled to be closed, and if the automatic door is closed, the automatic door is controlled to be kept closed. Such control can prevent a child from going out alone or opening/closing the automatic door for play, for example. Whether or not the moving object is a child can be identified based on the face, standard body shape, and the like, for example. Note that, even when control for closing the automatic door is performed based on the condition, if a human that is to pass through the automatic door may be caught in the automatic door, from the viewpoint of safety, control may be performed to keep the automatic door open by giving priority to the human who is to pass therethrough, for example.

On the other hand, if a child is accompanied by a guardian, the automatic door may be opened. Thus, the priority of the age group “adult”, which is moving object attribute information, may be set higher than that of the age group “child”. As a result, even if the moving object is identified as a “child” in the real time image, if another moving object in the same real time image is identified as an “adult”, priority is given to the latter, and the opening/closing condition “open” associated therewith can be preferentially selected. Note that, whether or not the moving object identified as an “adult” is a guardian of the moving object identified as a “child” can also be associated with the opening/closing condition where the attribute condition of the moving object is set to a combination of “age group” and “the number of people (including the distance between humans)”, for example. That is, if the real time image includes two or more moving objects, one of the moving objects is identified as “child”, the other of the moving objects is identified as “adult”, and the distance between the moving objects in the real time image is less than a threshold, the moving objects can be identified as “guardian accompanying child” or “child accompanied by guardian”, and thus this attribute information can be associated with the opening/closing condition “close”, for example.

(A3) Passing-by

A human walking in the vicinity of the automatic door may cross the automatic door without passing through the automatic door. In this example, it is possible to associate, as the passage assistance information, the moving object movement information “movement direction is direction toward the automatic door”, “face orientation is in direction of automatic door”, or “eye line extends in the direction of the automatic door” with the opening/closing condition “open”, which is a passage condition. In this case, if moving object movement information is identified through image analysis of the acquired real time image, as corresponding to any one of the pieces of movement information, the associated opening/closing condition “open” is selected, and the signal thereof is output to the automatic door. If the automatic door is open, the automatic door is then controlled to be closed, and if the automatic door is closed, the automatic door is controlled to be kept closed. Such control can prevent passing persons who only cross the automatic door from opening the automatic door, for example. A more specific description will be given later.

Specific Example B

Example B is an example in which the passage condition is the timing when the automatic door is opened/closed.

If the automatic door is opened/closed through detection performed by a human detecting sensor, usually, control is only performed through detection of a moving object at a given distance from the automatic door such that the automatic door is opened, and closed after a given period of time. Therefore, there are issues that the passerby cannot reach the automatic door while the automatic door is open, or the passerby cannot pass through the automatic door and collides with the automatic door, for example. According to this example, not only the opening/closing of the automatic door but also the timing to open the automatic door, the timing to close the automatic door, and the opening width of the automatic door are controlled according to the passing persons, and thus safe passage and elimination of congestion can be achieved.

In this example, the camera that acquires images of the surrounding region of the automatic door is usually fixed. Thus, in the surrounding region of the automatic door, a region that is acquired as a real time image or the like can be preset, and the distance to the automatic door when a human enters this region can also be determined. In view of this, if a human is identified in the real time image, at what timing (e.g., how many seconds) the automatic door is opened from when the human is identified, and at what timing (e.g., how many seconds after the automatic door is opened) the automatic door is closed, or the like, can be set in any manner. Specifically, the timing can be set based on the walking speed of a human that can be considered to be an average, for example. The following describes a specific example of adjustment regarding the opening timing and the closing timing, which are provided based on the walking speed of humans that is considered as an average and are used as “reference conditions” regarding the opening/closing of the automatic door.

(B1) Movement Speed

If a human walks fast or rushes in, the human may collide with the automatic door that is not fully open. In this example, it is possible to associate, as the passage assistance information, the moving object movement information “movement speed is higher than or equal to given speed” with the opening/closing condition “open at earlier timing than under reference condition”, which is a passage condition. There is no particular limitation on the given speed, and it is possible to set the speed at which a human walks fast, the speed at which a human rushes in, or the like, for example. In this case, if movement information is identified through image analysis of the acquired real time image, as “movement speed is higher than or equal to given speed”, the associated opening/closing condition “open at earlier timing than under reference condition” is selected, and the signal thereof is output to the automatic door. The movement speed can be quantified by identifying a human from a plurality of real time images over time, for example. Even when the object moving to the automatic door rushes in the automatic door, such control can prevent the risk of an object colliding with the automatic door and enables the object to safely pass through the door, for example. A more specific description will be given later.

On the other hand, if a moving object is a human who walks slowly, such as the elderly, the automatic door may be closed. In this example, it is possible to associate, as the passage assistance information, the moving object movement information “movement speed is lower than or equal to given speed” with the opening/closing condition “close at later timing than under reference condition”, which is a passage condition. There is no particular limitation on the given speed, and it is possible to set the speed of slow walk, the speed of walk using a walking aid such as a cane, or the like, for example. In this case, if movement information is identified through image analysis of the acquired real time image, as “movement speed is lower than or equal to given speed”, the associated opening/closing condition “close at later timing than under reference condition” is selected, and the signal thereof is output to the automatic door. The movement speed can be quantified by identifying a human from a plurality of images over time, for example. Even when an object moving to the automatic door walks slowly, such control enables the object to safely pass through the door with time to spare and without rushing, for example.

(B2) Plurality of People

If a plurality of people pass through the automatic door, congestion may occur in the vicinity of the automatic door. In this example, it is possible to associate, as the passage assistance information, the moving object attribute information “number of people is two or more” with the opening/closing condition “open at earlier timing than under reference condition”, which is a passage condition. There is no particular limitation on the number of people, and it is possible to set the number of people to two or more, for example. In this case, if moving object attribute information is identified through image analysis of the acquired real time image, as “number of people is two or more”, the associated opening/closing condition “open at earlier timing than under reference condition” is selected, and the signal thereof is output to the automatic door. Even when multiple people move to the automatic door, such control can avoid congestion and enables all people to pass through the automatic door, for example. Also, in a similar manner, the opening width of the automatic door may be controlled according to the number of people that pass through the automatic door and the spreading width of the people.

(B3) Bidirectional Passage

In the case of an automatic door for the entrance and exit, persons bidirectionally pass through the automatic door, and thus congestion may occur because persons approach each other and pass by each other. In view of this, in this example, it is possible to associate, as the passage assistance information, the moving object movement information “movement direction is bidirectional approach” with the opening/closing condition “open at earlier timing than under reference condition”, which is a passage condition. In this case, if movement information is identified through image analysis of the acquired real time image, as “bidirectional approach”, the associated opening/closing condition “open at earlier timing than under reference condition” is selected, and the signal thereof is output to the automatic door. “Bidirectional approach” may be determined when persons are identified in both a real time image acquired on the exit side and a real time image acquired on the entrance side at the same time, for example. Even when persons approach each other from both sides and pass by each other, such control enables the persons to smoothly pass through the door bidirectionally, for example. Also, in a similar manner, the opening width of the automatic door may be controlled according to the number of people that pass through the automatic door and the spreading width of the people.

(B4) Presence or Absence of Accessory

When a person is walking while carrying a large baggage, pushing a stroller, a shopping car, a wheelchair, or the like, or when a person is walking with a cane or the like, it may take time to walk and the automatic door may close. In this example, it is possible to associate, as the passage assistance information, the moving object attribute information “an accessory is present” with the opening/closing condition “open at earlier timing and close at later timing than under reference condition”, which is a passage condition. In this case, if moving object attribute information is identified through image analysis of the acquired real time image, as “accessory is present”, the associated opening/closing condition “open at earlier timing and close at later timing than under reference condition” is selected, and the signal thereof is output to the automatic door. Even when an object moving to the automatic door has the accessory, such control also enables the object to safely pass through the door with time to spare and without waiting for opening or rushing, for example. Note that the timing can be determined as appropriate depending on the type of accessory, for example. Also, in a similar manner, the opening width of the automatic door may be controlled according to the number of people that pass through the automatic door and the spreading width of the people.

The presence or absence and the type of the accessory can be detected through image analysis, for example. In the image analysis, after a person who has an accessory is identified, it is possible to identify the accessory based on the size, shape, and the like thereof, such as the longitudinal and lateral widths thereof, for example. Also, the time it takes for the person who has the moving accessory to reach the automatic door, the time it takes for the person to complete the passage, and the like can also be estimated based on data regarding the past passage of people with the same attributes, for example.

(B5) Passage in Closing State

When a person tries to pass through the automatic door at the timing when the automatic door is closing, the person may collide with the automatic door. In this example, it is possible to associate, as the passage assistance information, the moving object attribute information “human” with the opening/closing condition “open at earlier timing than under reference condition when automatic door is closing”, which is a passage condition. Even when an object moving to the automatic door walks slowly, such control enables the object to safely pass through the door with time to spare and without rushing, for example.

Specific Example C

Example C is an example in which the passage condition is a passage guide condition for the automatic door user.

(C1) Standstill

If a person stands still in front of or behind the automatic door, people may collide with each other, or congestion may occur. In this example, it is possible to associate, as the passage assistance information, the moving object movement information “movement speed is zero (no motion)” with the passage guide condition “guidance of “please do not stop””. In this case, when movement information is identified as “no movement” through image analysis of the acquired real time image, the associated passage guide condition “guidance of “please do not stop”” is selected, and the signal thereof is output. “Standstill” can be identified through image analysis of multiple images over time, for example. There is no particular limitation on a period of time of standstill, and it is possible to set the period of time of standstill to 30 seconds or longer, for example. If the guidance is sound information, sound information is output to the speaker and the sound of “please do not stop” is played, for example. If the guidance is visual information, the visual information is output to the signage, and the letters “please do not stop” are displayed, for example. Such control suppresses standstill, facilitates passage through the automatic door, and prevents congestion, for example.

(C2) Bidirectional Passage

As described above, when persons bidirectionally pass through the automatic door, if the number of persons is large, they may wait for passing through the automatic door due to mixture of persons moving in different directions. In this example, it is possible to associate, as the passage assistance information, information “predetermined number or more of people in each direction” obtained by combining the moving object attribute information “number of people” and the moving object movement information “movement direction” with the passage guide condition “guidance of “please keep to left””. In this case, when the moving object attribute information and the movement information are identified as “predetermined number or more of people are present in each direction on exit side and entrance side” through image analysis of the acquired real time images on the exit side and the entrance side, the associated passage guide condition “guidance of “please keep to left”” is selected, and the signal thereof is output. If the guidance is sound information, sound information is output to the speaker and the sound of “please keep to left” is played, for example. If the guidance is visual information, the visual information is output to the signage, and the letters “please keep to left” are displayed, for example. Such control can control the flows of people who are entering and exiting and prevent congestion, for example. This example is suitable when there is one automatic door, for example.

There is no particular limitation on the predetermined number of people, and the predetermined number of people can be set as appropriate according to the size of the automatic door, the place where the automatic door is installed, and the like, for example. As a specific example, the predetermined number of people may be set to 10 or more on the exit side and the entrance side. Also, when the number of people is less than 10 on one of the exit side and the entrance side, or when the number of people is less than 10 on both the exit side and the entrance side, the output of the passage guide condition may be ended. Furthermore, guide conditions that allow smoother passage may be selected by determining which of the left side or the right side a predetermined number or more of people are present, on each of the exit side and the entrance side.

(C3) Assignment of Plurality of Automatic Doors

If a plurality of automatic doors are arranged side-by-side, the automatic doors are assigned to doors only for entrance and doors only for exit in advance, for example. However, many people are entering or many people are exiting depending on a time slot, and the ratio assigned at first may not always be appropriate, resulting in congestion, for example. In this example, it is possible to associate, as the passage assistance information, “the ratio of the number of people on the entrance side to the number of people on the exit side differs from the ratio of the number of automatic doors only for entrance and the number of automatic doors only for exit” regarding the moving object attribute information “the number of people” with the guide condition “the display only for entrance and the display only for exit are changed such that the ratio of the number of automatic doors only for entrance to the number of automatic doors only for exit matches the ratio of the number of people on the entrance side and the number of people on the exit side”. In this case, with regard to an automatic door group constituted by a plurality of automatic doors, the number of people is counted through image analysis of the real time image on the entrance side and the real time image on the exit side, and when the moving object attribute condition is identified as “the ratio of the numbers of people on the entrance side and the exit side differs from the ratio of the number of automatic doors only for entrance and the number of automatic doors only for exit”, the associated guide condition is selected, and the signal thereof is output. Specifically, if the ratio of the numbers of people on the entrance side and the exit side is 3:1 in a state where the ratio of the number of automatic doors only for entrance and the number of automatic doors only for exit is 2:2, a signal with a ratio of 3:1 between the automatic door only for entrance and the automatic door only for exit is output so as to match the ratio of the numbers of people, for example. In the case of visual information, the signal is output to a display unit such as signage, and with regard to each automatic door, “only for entrance” and “only for exit” are displayed so as to achieve 3:1, for example. Accordingly, it is possible to control the flows of people who are entering and people who are exiting by increasing the display for the entrance only when many people are entering, and increasing the display for the exit only when many people are exiting, and to prevent congestion, for example. Also, which automatic door a larger number of people are present in front of may be considered when determining which automatic door is to be dedicated to the entrance or the exit, for example,

(C4) Passage of Visually Impaired Persons

In this example, it is possible to associate, as the passage assistance information, the moving object attribute information “there is white cane, which is accessory, for visually impaired person” with the guide condition “sound guidance of “automatic door is open””, which is a passage condition. In this case, when the moving object attribute information is identified as “there is white cane for visually impaired person” through image analysis of the acquired real time image, the associated guide condition “sound guidance of “automatic door is open”” is selected, and the signal thereof is output to the speaker. A white cane can be identified through image analysis of images, for example. Such control allows safe passage for a visually impaired person, for example.

(C5) Other Examples of Announcements

As described above, when a guardian is accompanying a child, in order to avoid collision with a person who enters from the other side, it is possible to identify the path of the guardian (e.g., right/left/center) and the attributes (e.g., the entering speed, entering angle, the presence or absence of an accessory) of a person who enters from the other side, display the announcement for avoiding collision on the signage, or perform announcement by voice from the speaker, for example. In this case, examples of the announcement for the guardian side include “there is a human who runs in from other side. please be careful”, and examples of the announcement for a person who is entering from the other side include “people accompanying child come in from other side. please be careful.”, or “there is child on other side. please be careful.” and the like.

If a passerby is an impaired person, the passerby may be notified of the location of an elevator, an escalator, or the like by displaying that location on signage or by sound or the like, for the convenience of movement, for example. In this case, sound announcements such as “elevator is located on left side after moving 50 m forward” are provided, or a floor image in the travelling direction and the arrow for the path are displayed on signage through AR display, for example.

If a passerby has a carry bag as an accessory and the attributes are identified as a foreigner, he/she may be an inbound tourist. Therefore, attention may be announced in (multiple) languages according to the presumed nationality, for example.

This example can be applied to public transportation vehicles, for example. If an impaired person or a person who has an accessory and plans to board a train is identified in a real time image of the surrounding region of the gate (automatic door) of the station platform, the congestion status of the vehicle to be boarded, the uncrowded vehicle, and the like may be output and presented to the speaker of the gate, the signage, or the like, before the vehicle arrives, for example. Also, before the vehicle stops at the station, a signal may be output to the vehicle, and an announcement inside the vehicle can be used to notify that the impaired person or the like will board on the vehicle at the next station.

Also, if a person carrying a large baggage as an accessory is identified, the time required to stop at the station can be estimated based on the congestion status of both the inside of the train and the station, and the past data regarding disembarking persons, and smooth boarding and disembarking can be facilitated through announcement of the conductor and on-time performance can also be assisted, for example.

(D) Other Announcements

In addition to the above examples, various pieces of information may be presented as announcements to passing persons as sound information or visual information, for example. Weather, temperature, advertisement, public transportation operation information, movement guidance for elevators, stairs, escalators, and the like may be presented to people who are exiting, for example, and movement guidance for impaired persons and various types of information regarding congestion regions and entrance areas may be presented to people who are entering, for example.

According to this embodiment, the attributes of a moving object are identified and the motion of the moving object is identified by performing image analysis, and thus it is possible to open/close an automatic door that is suitable for the attributes or motions and provide announcements in this manner. Thus, it is possible to improve convenience and prevent the occurrence of accidents, for example. It is possible to realize a more human-friendly environment because automatic doors are opened/closed and announcements are made according to characteristics of passing persons who have difficulty in smooth movement, such as passing persons with physical impairments, guardians accompanying children, elderlies, and passing persons with accessories, in particular. Also, the influence on the air conditioning in the facility can be sufficiently suppressed by appropriately opening/closing an automatic door, for example.

Embodiment 2

An embodiment for detecting a specific motion and executing automatic door open/close control will be described.

As shown in FIGS. 1 and 2, if the attribute information is the movement information, the passage assistance apparatus 1 may further includes a specific motion detection unit 16 as an optional configuration, for example. As shown in FIG. 2, with a hardware configuration of the passage assistance apparatus 1 in this embodiment, the CPU 100 also functions as the specific motion detection unit 16, for example. The description of Embodiment 1 above can be applied to this embodiment, unless otherwise stated.

In this embodiment, the storage unit 10 further stores specific motion information regarding a specific motion of a moving object and region information. There is no particular limitation on the specific motion, and examples thereof include actions such as a passing-by or rushing motion. The specific motion information is associated with the passage condition. More specifically, as will be described later, specific motion information regarding passing-by is information for detecting passing-by such as “the boundary line of a control region and vector information regarding the moving object (moving object vector information) intersect at two points”, for example. As will be described later, specific motion information regarding rushing is information for detecting rushing such as “the movement speed of the moving object entering the control region is higher than or equal to a preset speed, and the moving object vector information indicates that the moving object moves in a direction toward the automatic door”, for example.

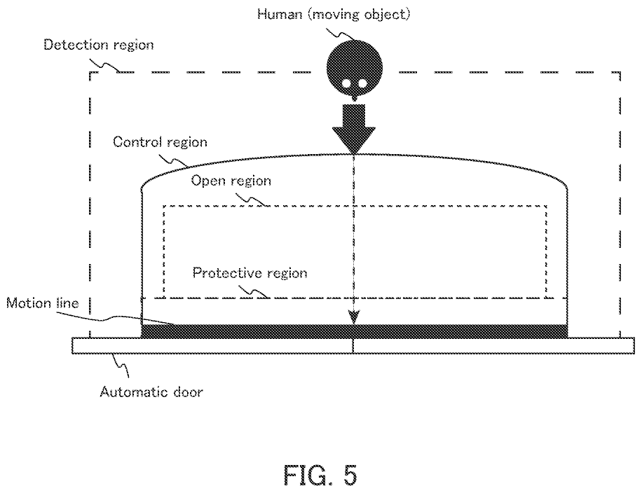

The region information is information regarding a given region from the automatic door, and includes control region information regarding the control region set in the region. FIG. 5 shows an example of the region information. As shown in FIG. 5, the region information includes a detection region, an open region, a protective region, the control region, and the like, and the ranges thereof can be set suitably, for example. As shown in FIG. 5, the regions are set such that the open region, the protective region, and the control region are present in the detection region. Also, the regions are set such that the open region and the protective region are present in the control region. Note that, as shown in FIG. 5, the open region and the protective region are set such that the protective region and the open region are set such that these region do not overlap each other and are adjacent to each other in the order of the protective region and the open region from the automatic door. It is preferable that the lateral width of the detection region, the open region, the protective region, and the control region is the same as or larger than the lateral width of the automatic door, for example. There is no particular limitation on the shape of each of the regions, and the shape thereof may be a quadrangular or semicircular shape, for example. However, as shown in FIG. 5, the shape of the control region is preferably a shape such that a side opposite to the side that is in contact with the automatic door has an arc shape that is curved in a direction away from the automatic door (hereinafter, also referred to as “semi-cylindrical shape”). Because the shape of the control region is semi-cylindrical, the accuracy of the two-point intersection, which will be described later, is improved, for example. Specifically, the detection region refers to a region where the real time image can be analyzed, for example, and the distance from the side that is in contact with the automatic door to the side opposite to the side is within a range of about 5000 mm, for example. The protective region refers to a region where the automatic door is not closed when a moving object or an object is present, that is, the open state is maintained, for example, and the distance from the side that is in contact with the automatic door to the side opposite to the side is within a range of about 200 mm, for example. The open region refers to a region where the automatic door is opened if the moving object or an object (a wheelchair, a shopping cart, or the like) is present (except for passing-by), for example. The distance from the side that is in contact with the automatic door to the side where the protective region and the open region are in contact with each other (i.e., the opposite side of the protective region) is about 201 mm, and the distance from the side that is in contact with the automatic door to the opposite side of the open region is within a range of about 1000 mm, for example. The control region refers to a region where a specific motion such as a rushing or passing-by motion is detected and that is formed by the boundary line, and the distance from the side that is in contact with the automatic door to the side opposite to the side is within a range of about 3000 mm, for example. These ranges are merely examples, and may also be set suitably. Also, the protective region and the open region may be set so as to overlap with each other.

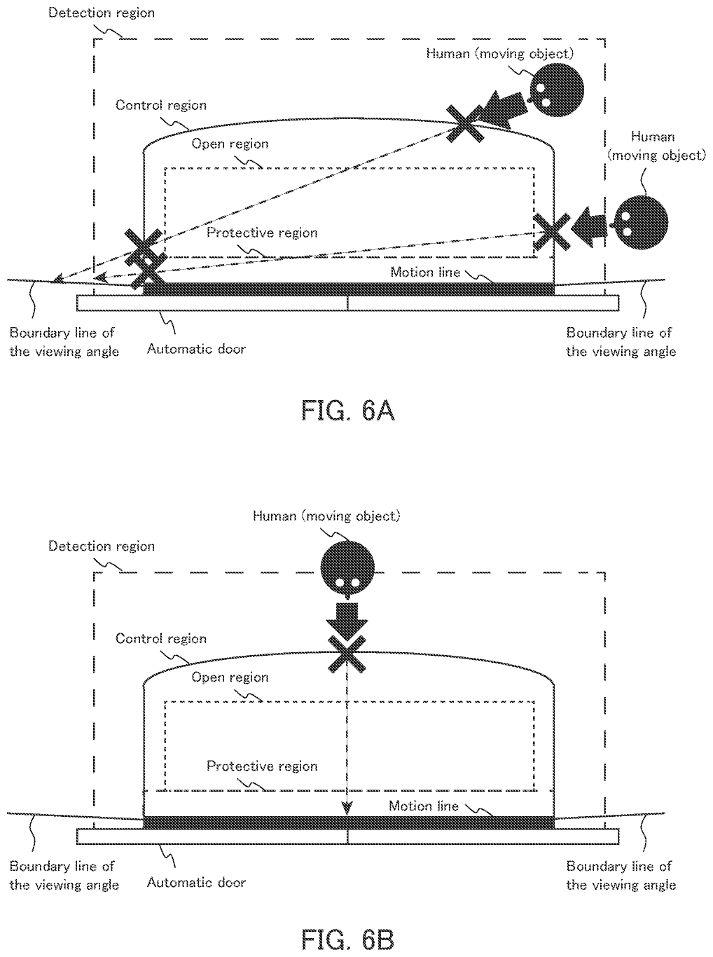

In this embodiment, the identification unit 12 identifies the attribute information that includes the moving object movement information, with respect to the real time image. That is, the identification unit 12 identifies at least one of the movement speed of the moving object and moving object vector information (movement direction, face orientation, eye line, etc.). As shown in FIG. 5, the vector information can be shown by using an estimation line and an extension line, for example. The estimation line indicates vector information regarding a person at the present time, for example. The extension line indicates future vector information calculated at real time from the estimation line, for example. As shown in FIG. 6(A), the estimation line is preferably calculated until the estimation line intersects the boundary line of the viewing angle of the camera, for example.

The specific motion detection unit 16 detects a specific motion of the moving object using the control region information and the identified attribute information. Specifically, if the specific motion information is information regarding rushing, the specific motion detection unit 16 detects the motion of the moving object as “rushing motion” if the movement speed of the moving object entering the control region is higher than or equal to a preset speed, and the moving object vector information indicates that the moving object moves in a direction toward the automatic door. There is no particular limitation on the speed, and the speed can be set suitably and be 1.4 m/sec or higher, for example. Also, the speed may be set for each gender or age group of a person, for example.

FIG. 6 is used to describe processing performed by the specific motion detection unit 16 if the specific motion information is information regarding a passing-by motion. In this case, as shown in FIG. 6(A), the specific motion detection unit 16 detects the motion of the moving object as “passing-by motion” if the boundary line of the control region and the moving object vector information (estimation line and extension line) intersect at two points. On the other hand, as shown in FIG. 6(B), the specific motion detection unit 16 does not detect the motion of the moving object as “passing-by” if the boundary line of the control region and the moving object vector information (estimation line and extension line) intersect at one point, for example. Specifically, as shown in FIG. 6(B), the specific motion detection unit 16 does not detect the motion of the moving object as “passing-by” if vector information (estimation line and extension line) intersect a motion line, for example. If vector information (estimation line and extension line) intersect the motion line, the moving object is identified as moving to the automatic door, and as described above, control is performed so as to open the automatic door when the automatic door is close, for example. The motion line is a line set along the lateral direction of the automatic door and is set to have a length fitting within the control region, for example.

The passage condition selection unit 13 selects a passage condition that is associated with specific motion information in the storage unit 10 that has matched the detected specific motion.

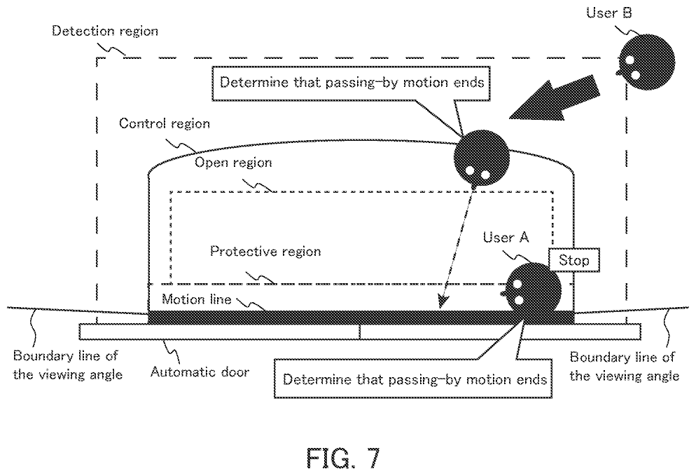

Also, the identification unit 12 detects the specific motion and then may further identify the attribute information that includes the moving object movement information, with respect to the real time image. The identification unit 12 may identify only the same type of attribute information as attribute information used to detect the specific motion, or may identify other types of attribute information, for example. The same type of attribute information refers to movement speed and vector information when rushing has been detected, and refers to vector information when passing-by has been detected, for example. Subsequently, the specific motion detection unit 16 detects at least either the end or continuation of the specific motion of the moving object, based on the moving object movement information identified after the specific motion has been detected. Detection of at least either the end or continuation of the specific motion of the moving object may be executed at regular time intervals and fixed distance intervals (e.g., 50 mm/sec or the like), for example. FIG. 7 shows an example for detecting the end of a specific motion of the moving object. Although a passing-by motion is shown in FIG. 7 as the specific motion, the specific motion is not limited to this. A passing-by motion of a user A shown in FIG. 7 is detected, and then the user A stops in the protective region. The identification unit 12 identifies the position and stoppage of this user A. Specifically, whether or not the user A is present in the protective region can be determined based on the motion point of the head of the user A, for example. The specific motion detection unit 16 then detects the end of passing-by when the position where the user A has stopped is within the protective region, for example. On the other hand, if the position where the user A has stopped is located outside the protective region, the specific motion detection unit 16 need not detect the end of the passing-by motion, for example. Also, after the passing-by motion of a user B shown in FIG. 7 is detected, the user B turned the face toward the automatic door. The identification unit 12 identifies vector information regarding the user B again. If the specific motion detection unit 16 has determined that the boundary line of the control region and the motion object vector information (estimation line and extension line) intersect at one point, that is, if the specific motion detection unit 16 has determined that the boundary line of the control region and the motion object vector information do not intersect at two points, or if the motion object vector information intersects only the motion line without intersecting the boundary line of the control region, the specific motion detection unit 16 detects that the passing-by motion has ended, assuming that at least one of the users A and B is within the control region. Also, a case where the specific motion is a rushing motion will be described. If the movement speed of the moving object identified by the identification unit 12 becomes lower than the movement speed of the moving object identified before the specific motion is detected, and is lower than or equal to a preset speed, or if the vector information is no longer a direction to the automatic door, the specific motion detection unit 16 detects that the rushing motion has ended, for example. On the other hand, if the specific motion detection unit 16 has also detected the same specific motion in the identification performed after the specific motion has been detected, for example, the specific motion detection unit 16 detects that the specific motion is continuing, for example. The specific motion detection unit 16 may detect a change in the specific motion, for example. That is, after the specific motion detection unit 16 has detected the end of the specific motion, the specific motion detection unit 16 may further detect other specific motions, for example. The passage condition selection unit 13 then selects a passage condition that is associated with at least one of attribute information in the storage unit 10 that has matched the identified attribute information, and the specific motion information regarding a specific motion of other moving objects other than the specific motion whose end has been detected.

Next, an automatic door passage assistance method according to this embodiment will be described. The passage assistance method according to this embodiment can be implemented using the passage assistance apparatus 1 shown in FIGS. 1 to 3, for example. Note that the passage assistance method according to this embodiment is not limited to use of the passage assistance apparatus 1 shown in these diagrams. Also, a description of the passage assistance method according to this embodiment can be applied to the above-described passage assistance apparatus 1.

With the passage assistance method according to this embodiment, the above-described specific motion information regarding the specific motion of the moving object and the region information are further used. With the passage assistance method according to this embodiment, it is possible to use the specific motion information and the region information that are stored in the storage unit 10 in the passage assistance apparatus 1 of the present invention, for example. Also, the passage assistance method according to this embodiment includes a storing step, for example, and the specific motion information and the region information may be stored in the storing step. The storing step can be executed by the storage unit 10 of the passage assistance apparatus 1, for example.

The passage assistance method according to this embodiment further includes a specific motion detection step. In the passage assistance method according to this embodiment, the identification step is a step of identifying the attribute information that includes the moving object movement information, with respect to the real time image, and can be executed by the identification unit 12 of the passage assistance apparatus 1, for example. The specific motion detection step is a step of detecting a specific motion of the moving object using the control region information and the identified attribute information, and can be executed by the specific motion detection unit 16 of the passage assistance apparatus 1, for example. In the passage assistance method according to this embodiment, the passage condition selection step is a step of selecting a passage condition associated with specific motion information in the storage unit 10 that has matched the detected specific motion, and can be executed by the passage condition selection unit 13 of the passage assistance apparatus 1, for example.

If the specific motion information includes information regarding a rushing motion, the specific motion detection step may be a step of detecting the motion of the moving object as “rushing motion” if the movement speed of the moving object entering the control region is higher than or equal to a preset speed, and the moving object vector information indicates that the moving object moves in a direction toward the automatic door, for example. Also, if the specific motion information includes information regarding a passing-by motion, the specific motion detection step may be a step of detecting the motion of the moving object as “passing-by motion” if the boundary line of the control region and the moving object vector information intersect at two points.

The identification step may be a step of detecting the specific motion and further identifying the attribute information that includes the moving object movement information, with respect to the real time image, for example. In this case, the specific motion detection step is a step of detecting at least either the end or continuation of the specific motion of the moving object based on the moving object movement information identified after the specific motion has been detected. Also, the passage condition selection step is a step of selecting a passage condition that is associated with at least one of attribute information in the storage unit 10 that has matched the identified attribute information, and the specific motion information regarding a specific motion of other moving objects other than the specific motion whose end has been detected.

According to this embodiment, by performing image analysis in this manner, it is possible to open/close the automatic door that is suitable for a specific motion such as a passing-by or rushing motion. Thus, it is possible to improve convenience and prevent the occurrence of accidents, for example.

Embodiment 3

An embodiment in which switching is performed between automatic door open/close control that is based on sensor data and automatic door open/close control that is based on a real time image will be described.

As shown in FIGS. 1 and 2, the passage assistance apparatus 1 may further include a sensor data acquisition unit 17 and a switching unit 18 as an optional configuration, for example. As shown in FIG. 3, with a hardware configuration of the passage assistance apparatus 1 in this embodiment, a CPU 100 further functions as the sensor data acquisition unit 17 and the switching unit 18, for example. The description of the embodiments 1 and 2 can be applied to this embodiment, unless otherwise stated.

In this embodiment, the storage unit 10 stores the passage assistance information, the specific motion information, and the region information. In the passage assistance information, the passage condition is associated with the attribute information and attribute information of sensor data regarding the surrounding region of the automatic door. The sensor data attribute information is information regarding a threshold, a numerical range, and the like of the sensor data, and is information set from the viewpoint of detecting the presence of a moving object, an object, and the like, for example. More specifically, examples of the sensor data attribute information include whether or not there is a person in the surrounding region of the automatic door, whether or not an object is a person, the weather, the temperature, and the like of the surrounding region of the automatic door. Also, the sensor data attribute information may be directly identified from the sensor data in the identification of the sensor data by the identification unit 12, which will be described later, or the sensor data attribute information may be identified from a combination of a plurality of attributes identified from the sensor data, for example.

Also, the sensor data attribute information in the passage assistance information 15 of the storage unit 10 may be sensor data, for example. In this case, in the identification of the sensor data by the identification unit 12, which will be described later, the sensor data attribute information can also be identified by comparing the former sensor data with the acquired sensor data, for example. If the sensor data attribute information in the passage assistance information 15 is sensor data, a specific example thereof is past sensor data regarding the surrounding region of the automatic door, for example.

As described above, in the passage assistance information 15, the passage condition and the sensor data attribute information are also associated with each other. A suitable passage condition can be suitably set for each piece of the sensor data attribute information as the passage condition, for example, and specifically, a passage condition that is suitable for an estimated situation can be set based on the sensor data attribute information. The above description can be applied to the passage condition, for example.

There is no particular limitation on the passage condition associated with the sensor data attribute information, and the passage condition may be a hypothetical condition obtained through presumption, or may also be any condition set based on past information, for example. Also, as described above, the sensor data attribute information may be sensor data, for example. In this case, sensor data (e.g., sensor data regarding the surrounding region of the automatic door) that is considered to be suitable for a given passage condition may be stored in the storage unit 10 as the sensor data attribute information, and may be associated with the passage condition. As a specific example, if the announcement “please be careful not to slip” to an automatic door user is set as a passage guide condition, for example, sensor data regarding the state where slip may occur, that is, sensor data regarding raining in the surrounding region of the automatic door, or the like may be stored in the storage unit 10 as the sensor data attribute information, and the passage condition of the announcement may be associated therewith.

The passage assistance information may be a model produced through training using, as training data, a set of sensor data regarding the surrounding region of the automatic door and a passage condition suitable for the state of the sensor data, for example. The “sensor data regarding the surrounding region of the automatic door” as the sensor data attribute information may be sensor data regarding the surrounding region of the automatic door that is an actual target, sensor data regarding an environment in which the automatic door is present (i.e., sensor data regarding a surrounding region of another automatic door), or sensor data regarding an event that may occur in the surrounding region of the automatic door (i.e., sensor data that does not include the automatic door), for example.

The sensor data acquisition unit 17 acquires sensor data. The sensor data is data acquired by a sensor device attached to the automatic door. There is no particular limitation on the sensor device, and examples thereof include an infrared sensor, a temperature sensor, and a weight sensor. There is no particular limitation on the sensor data, and example thereof may be data regarding a weight, data regarding heat, or data regarding a motion. The sensor data acquisition unit 17 acquires the sensor data from the sensor device via the communication network, for example.

In this embodiment, as described above, the identification unit 12 identifies the image attribute information that includes the moving object movement information. Furthermore, the identification unit 12 identifies the sensor data attribute information, with respect to the sensor data.

In this embodiment, the passage condition selection unit 13 further includes a sensor data open/close control unit 131 and an image analysis open/close control unit 132. If the specific motion is not detected by the specific motion detection unit 16, the sensor data open/close control unit 131 selects a passage condition associated with sensor data attribute information in the storage unit 10 that has matched the identified sensor data attribute information. Specifically, it is possible to associate, as the passage assistance information, the sensor data attribute information “there is human” with the opening/closing condition “open”, which is a passage condition, and associate the sensor data attribute information “there is no human” with the opening/closing condition “close”, which is a passage condition. On the other hand, if the specific motion has been detected by the specific motion detection unit 16, the image analysis open/close control unit 132 selects a passage condition that is associated with specific motion information in the storage unit 10 that has matched the detected specific motion. That is, the image analysis open/close control unit 132 is similar to the passage condition selection unit 13 described in Embodiment 2 above.

Depending on whether or not the specific motion has been detected, the switching unit 18 executes switching between automatic door open/close control that is performed by the sensor data open/close control unit 131 based on sensor data and automatic door open/close control that is performed by the image analysis open/close control unit 132 based on a real time image. Specifically, as described above, if the specific motion is not detected by the specific motion detection unit 16, the switching unit 18 performs control so as to execute processing performed by the sensor data open/close control unit 131, for example. On the other hand, if the specific motion has been detected by the specific motion detection unit 16, the switching unit 18 performs control so as to execute processing performed by the image analysis open/close control unit 132, for example.

In this embodiment, the output unit 14 outputs the selected passage condition. That is, the output unit 14 outputs either the passage condition associated with the sensor condition in the storage unit 10 or the passage condition associated with the specific motion information in the storage unit 10.

In this embodiment, similarly to Embodiment 2 above, the identification unit 12 detects the specific motion and then may further identify the attribute information that includes the moving object movement information, with respect to the real time image. Subsequently, similarly to Embodiment 2 above, the specific motion detection unit 16 may detect at least either the end or continuation of the specific motion of the moving object, based on the moving object movement information identified after the specific motion has been detected. In this case, depending on a result of detection of at least either the end or continuation of the specific motion, the switching unit 18 executes switching between automatic door open/close control that is performed by the sensor data open/close control unit 131 based on sensor data and automatic door open/close control that is performed by the image analysis open/close control unit 132 based on a real time image. Specifically, if the end of the specific motion has been detected, the sensor data open/close control unit 131 selects a passage condition associated with sensor data attribute information in the storage unit 10 that has matched the identified sensor data attribute information. On the other hand, if the continuation of the specific motion has been detected, the image analysis open/close control unit 132 selects a passage condition that is associated with specific motion information in the storage unit 10 that has matched the detected specific motion.

Next, an automatic door passage assistance method according to this embodiment will be described. The passage assistance method according to this embodiment can be implemented using the passage assistance apparatus 1 shown in FIGS. 1 to 3, for example. Note that the passage assistance method according to this embodiment is not limited to use of the passage assistance apparatus 1 shown in these diagrams. Also, a description of the passage assistance method according to this embodiment can be applied to the above-described passage assistance apparatus 1.

With the passage assistance method according to this embodiment, the above-described passage condition and passage assistance information associated with sensor data attribute information are further used. The passage assistance information, which is stored in the storage unit 10 in the passage assistance apparatus 1 according to the present invention, can be used in the passage assistance method according to this embodiment, for example. Also, the passage assistance method according to this embodiment includes a storing step, for example, and passage assistance information associated with the sensor data attribute information may be stored in the storing step. The storing step can be executed by the storage unit 10 in the passage assistance apparatus 1, for example.

The passage assistance method according to this embodiment further includes a sensor data acquisition step and a switching step. Also, the passage condition selection step further includes a sensor data open/close control step and an image analysis open/close control step.

First, the sensor data is acquired in the sensor data acquisition step. The sensor data acquisition step can be executed by the sensor data acquisition unit 17 in the passage assistance apparatus 1, for example. Then, similarly to Embodiment 1 above, a real time image of the surrounding region of the automatic door is acquired in the image acquisition step. Then, in the identification step, the attribute information that includes the moving object movement information is identified, with respect to the real time image, and the sensor data attribute information is identified, with respect to the sensor data. Similarly to Embodiment 2 above, in the specific motion detection step, a specific motion of the moving object is then detected using the control region information and the identified attribute information. In the switching step, depending on whether or not the specific motion has been detected, switching is executed between automatic door open/close control that is performed in the later-described sensor data open/close control step based on sensor data and automatic door open/close control that is performed in the later-described image analysis open/close control step based on a real time image. The switching step can be executed by the switching unit 18 in the passage assistance apparatus 1, for example. If the specific motion is not detected in the sensor data open/close control step, a passage condition associated with sensor data attribute information in the storage unit 10 that has matched the identified sensor data attribute information is selected. The sensor data open/close control step can be executed by the sensor data open/close control unit 131 in the passage assistance apparatus 1, for example. Also, if the specific motion has been detected in the image analysis open/close control step, a passage condition that is associated with specific motion information in the storage unit 10 that has matched the detected specific motion is selected. The image analysis open/close control step can be executed by the image analysis open/close control unit 132 in the passage assistance apparatus 1, for example. Similarly to Embodiment 1 above, the selected passage condition is output in the output step, and the processing ends.

Also, similarly to Embodiment 2 above, in the identification step, after the specific motion is detected, the attribute information that includes the moving object movement information may be further identified, with respect to the real time image. Subsequently, similarly to Embodiment 2 above, in the specific motion detection step, at least either the end or continuation of the specific motion of the moving object may be detected based on the moving object movement information identified after the specific motion has been detected. In this case, in the switching step, depending on a result of detection of at least either the end or continuation of the specific motion, switching is executed between automatic door open/close control that is performed in the sensor data open/close control step based on sensor data and automatic door open/close control that is performed in the image analysis open/close control step based on a real time image. Specifically, if the end of the specific motion has been detected, in the sensor data open/close control step, a passage condition associated with sensor data attribute information in the storage unit 10 that has matched the identified sensor data attribute information is selected. On the other hand, if the continuation of the specific motion has been detected, in the image analysis open/close control step, a passage condition that is associated with specific motion information in the storage unit 10 that has matched the detected specific motion is selected.

According to this embodiment, in this manner, it is possible to perform switching so as to perform automatic door open/close control based on image analysis if a specific motion such as a passing-by or rushing motion is detected, and perform automatic door open/close control that is based on sensor data if the specific motion is not detected. Accordingly, it is possible to open/close the automatic door that is more suitable for a specific motion such as a passing-by or rushing motion. Also, similarly to Embodiments 1 and 2 above, it is possible to improve convenience and prevent the occurrence of accidents, for example. A sensor is not required for automatic door open/close control based on image analysis, and thus it can be said that the automatic door open/close control based on image analysis is executed by software. As a result of enabling control by software, it is also possible to support “ventilation mode” in which the door is opened for a given period of time based on schedule data, for example.

Embodiment 4

It is also possible to further control passage assistance based on weather information, event information, date and time information, or the like, for example. That is, it is conceivable that the number of people who is entering and exiting changes depending on the weather, the presence or absence of events, the day of the week, a time slot, or the like, for example. Thus, if the relationship between these items in the past and the number of people who are entering and exiting, and the like are accumulated, the congestion situation can also be estimated by inquiring each item of the current situation with accumulated data. Then, as described in (C2) and (C3) of Embodiment 1 above, for example, an announcement about the flow control, a display for changing the ratio between the door only for exit and the door only for entrance, or the like can also be performed based on this estimated congestion situation.

Embodiment 5

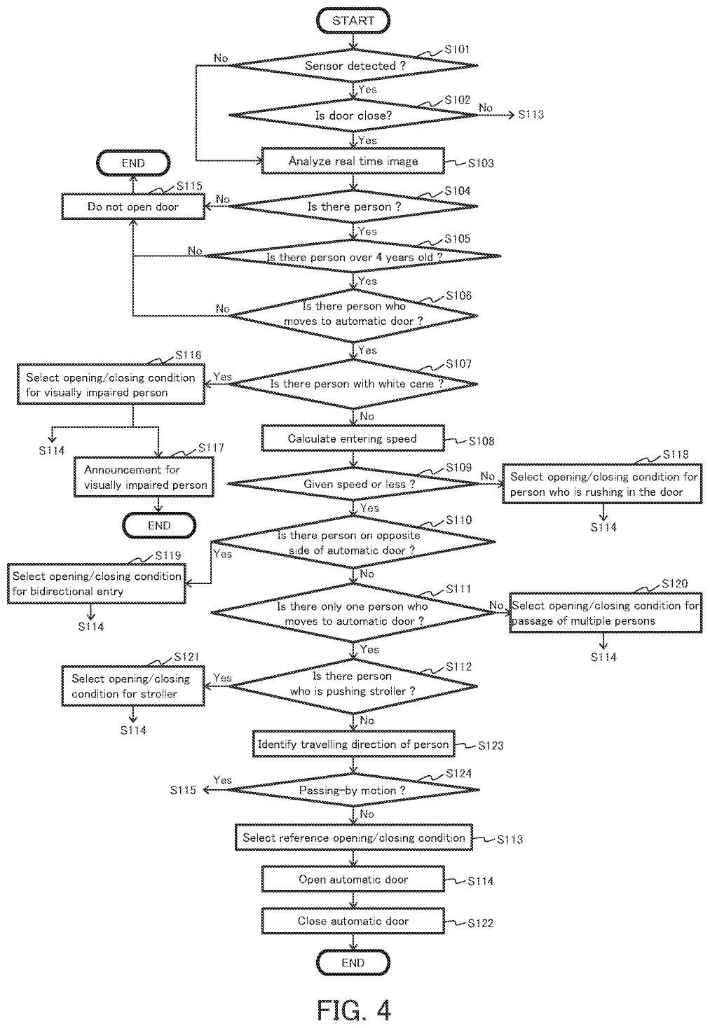

An example of the present invention will be described using the flowchart shown in FIG. 4. Note that the present invention is not limited to this example.

First, whether or not an object is detected by a sensor (infrared sensor) of the automatic door is determined (S101). If an object is detected (YES), whether the door is close is determined (S102). If the door is close (YES), a real time image is analyzed (S103). Furthermore, if the sensor does not detect an object (NO in S101), a real time image may also be analyzed (S103). Then, whether or not a person is present is identified by the identification unit 12 (S104), and if there is a person (YES in S104), whether there is a person over 4 years old is identified (S105). If there is a person over 4 years old (YES), whether there are one or more persons who move to the automatic door is further identified by the identification unit 12 (S106). If there are one or more persons who move to the automatic door (YES), whether there is a person who has a white cane is identified by the identification unit 12 (S107). If there is no person who has a white cane (NO), the entering speed of the person who moves to the automatic door is calculated by the identification unit 12 (S108), and the specific motion detection unit 16 detects a rushing motion whose speed is higher than or equal to a given speed (S109). Here, a general entering speed can be suitably set as “given speed”. Then, if the entering speed is the given speed or less (YES), whether there is a person on the opposite side of the automatic door is identified by the identification unit 12 (S110). If there is no person on the opposite side (NO), whether or not there is only one person who moves to the automatic door is identified by the identification unit 12 (S111). If there is only one person (YES), whether there is a person who is pushing a stroller is identified by the identification unit 12 (S112). If there is no person (NO), the traveling direction of the person is identified by the identification unit 12 (S123), and the passing-by motion is detected by the specific motion detection unit 16 (S124). If the passing-by motion is not detected (NO), a reference opening/closing condition is selected by the passage condition selection unit 13 (S113), the automatic door is opened (S114) and closed (S122) by the output unit 14 according to the opening/closing condition, and the processing ends (END). In this flow, the moving object is detected by the sensor, the moving object is a person and not an animal (YES in S104), the person is not a child (YES in S105), the person moves to the automatic door (YES in S106), the person is not a visually impaired person (NO in S107), the specific motion is not rushing in (YES in S109), there is no person who is entering from the opposite side (NO in 5110), the number of people who moves to the automatic door is one (YES in S111), the person is not pushing a stroller (NO in S112), and it is identified that the specific motion is not a passing-by motion (NO in S124). Therefore, the automatic door is opened/closed under the reference opening/closing condition (at open/close timing).

Also, if an object is detected by the sensor (YES in S101) and the door is open (NO in S102), then the reference opening/closing condition may be selected (S113), and the automatic door may also be opened (S114).

On the other hand, if it is identified that there is no person (NO in S104), through analysis of a real time image (S103), there is an animal or the like and not a person, and thus the automatic door is not opened (S115), and the processing ends (END). If there is a person (YES in S104) and there is no person over 4 years old (NO in S105), it is identified that there is only a child, and thus the automatic door is not opened (S115), and the processing ends (END). If there is a person over 4 years old (YES in S105) and only one person moves to the automatic door (NO in S106), it is identified that there is no person who moves to the automatic door, and thus the automatic door is not opened (S115), and the processing ends (END). If a passing-by motion is detected (YES in S124), it is identified that there is no person who moves to the automatic door, and thus the automatic door is not opened (S115), and the processing ends (END).

If there is a person who moves to the automatic door and has a white cane (YES in S107), an opening/closing condition for a visually impaired person is selected (S116), the automatic door is opened (S114), and an announcement for a visually impaired person is performed (S117). The announcement is sound guidance from the speaker, for example.

If the entering speed of the person who moves to the automatic door exceeds the given speed (NO in S109), the specific motion is detected as the rushing motion, and thus an opening/closing condition for a person who is rushing in the door is selected (S118), and the automatic door is opened (S114). If the rushing motion is detected, automatic door open/close control processing may be switched from open/close control that is based on sensor data to open/close control that is based on image analysis, for example. That is, the opening/closing condition is selected by the passage condition selection unit 13 (image analysis open/close control unit 132), for example.

If there is a person on the opposite side of the automatic door (YES in S110), the resulting motion is identified as bidirectional entry, and thus an opening/closing condition for bidirectional entry is selected (S119), and the automatic door is opened (S114).

If there is a person who is pushing a stroller (YES in S112), the opening/closing condition for a stroller is selected (S121), and the automatic door is opened (S114).

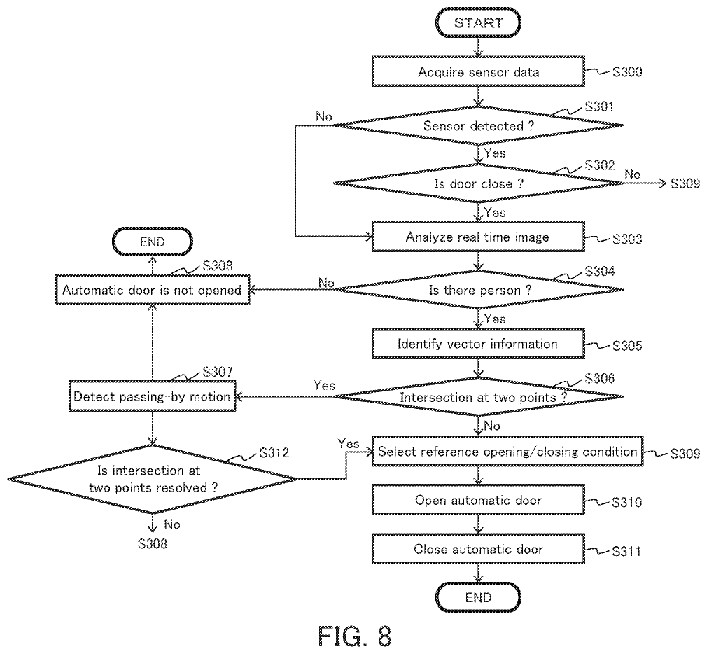

The flowchart shown in FIG. 8 is used to more specifically describe detection of the passing-by motion and controlling the opening/closing of an automatic door.

It is presumed that automatic door open/close control processing is being executed based on sensor data in advance, for example.

First, sensor data is acquired from the sensor (infrared sensor) of the automatic door (S300), and the presence or absence of an object is detected from the sensor data (S301). If an object is detected (YES), it is determined whether the automatic door is close (S302). If the door is close (YES), a real time image is analyzed (S303). Furthermore, if the sensor does not detect an object (NO in S301), a real time image may also be analyzed (S303). Then, whether or not a person is present is identified by the identification unit 12 (S304), and if it is identified that there is a person (YES in S304), vector information regarding the person is further identified (S305). Then, whether the boundary line of the control region and the vector information intersect at two points is determined by the specific motion detection unit 16 (S306). If they intersect at two points (YES in S306), the motion of the person is detected as a passing-by motion (S307). If the passing-by motion is detected, automatic door open/close control processing may be switched from open/close control that is based on sensor data to open/close control that is based on image analysis, for example. Because it is identified that there is no person who moves to the automatic door, the automatic door is not opened (S308) according to the opening/closing condition selected by the passage condition selection unit 13 (image analysis open/close control unit 132), and the processing ends (END). On the other hand, if they do not intersect at two points (NO in S306), it will be identified that there is a person who moves to the automatic door. Therefore, the reference opening/closing condition is selected (S309), and the automatic door is opened (S310) and closed (S311) according to the opening/closing condition. The processing then ends (END). The step (S309) may be executed by the passage condition selection unit 13 described in Embodiment 2 above, or may be executed by the sensor data passage condition selection unit 131 described in Embodiment 3, for example. That is, if the boundary line of the control region and the vector information do not intersect at two points (NO in S306), it can be said that the specific motion detection unit 16 detects that there is no passing-by motion, or that the passing-by motion is not detected. Also, if the step is executed by the passage condition selection unit 13 described in Embodiment 2 above, an opening/closing condition that corresponds to the detection result “there is no passing-by motion” is selected (open/close control processing based on image analysis). On the other hand, if the step is executed by the sensor data passage condition selection unit 131 described in Embodiment 3 above, an opening/closing condition that corresponds to the sensor data acquired in the step (S300) is selected under the open/close control based on the sensor data, without executing the switching.

On the other hand, if it is identified that there is no person (NO in S304), there is an animal or the like and not a person, and thus the automatic door is not opened (S308), and the processing ends (END).

Also, the step (S305) and the step (S306) may be repeatedly executed at fixed intervals (e.g., 50 m/sec or the like) in a period from the process of the step (S307) to the process of the step (S308). As a result of repeatedly executing the steps, if it is determined, in the step (S306), that the boundary line of the control region and the vector information do not intersect at two points (NO in S306), the step (S309) to the step (S311) may also be executed.

Also, after the step (S307), whether or not the intersection at the two points has been resolved (e.g., whether the person has stopped in the protective region) may be detected (S312). If it is detected that the intersection at the two points is resolved (YES in S312), it is identified that the passing-by motion has ended (there is a person who moves to the automatic door), the reference opening/closing condition is selected (S309), and the automatic door is opened (S310) and closed (S311) according to the opening/closing condition. If stoppage has been detected (YES in S312), automatic door open/close control processing may be switched from open/close control that is based on image analysis to open/close control that is based on sensor data, for example. On the other hand, if stoppage is not detected, that is, if the intersection at the two points is not resolved (NO in S312), it is identified that the passing-by motion continues (there is no person who moves to the automatic door), and the automatic door is not opened (S308). If stoppage is not detected (NO in S312), automatic door open/close control processing may be maintained as open/close control that is based on image analysis, for example.

Also, if an object is detected by the sensor (YES in S301) and the door is open (NO in S302), the reference opening/closing condition may be selected (S309), and the automatic door may be opened (S310).

Embodiment 6

A program according to this embodiment causes a computer to execute the steps of the passage assistance method according to the present invention as a procedure. In the present invention, “procedure” may be read “processing”. Alternatively, the program according to this embodiment may be recorded on a computer readable recording medium, for example. There is no particular limitation on the recording medium, and examples thereof include a storage medium such as that described above. The passage assistance method according to the present invention may be executed by artificial intelligence (AI), for example.

Although the present invention was described with reference to the embodiments, the present invention is not limited to the above-described embodiments. Various changes that can be understood by those skilled in the art can be made to the configuration and details of the present invention within the scope of the present invention.

This application is based upon and claims the benefit of priority from Japanese Patent Application No. 2019-167588, filed on Sep. 13, 2019, the entire content of the disclosure is incorporated herein by reference.

(Supplementary Notes)

Some or all of the above example embodiments and examples may be described as in the following Supplementary Notes, but are not limited thereto.

### (Supplementary Note 1)

An automatic door passage assistance apparatus comprising:

a storage unit;

an image acquisition unit;

an identification unit;

a passing condition selection unit; and

an output unit,

wherein the storage unit is configured to store passage assistance information regarding passage through an automatic door,

a passage condition regarding passage through the automatic door and information regarding an attribute of an image of a surrounding region of the automatic door are associated with each other in the passage assistance information,

the passage condition is at least one of an automatic door opening/closing condition and a passage guide condition for an automatic door user,

the image acquisition unit is configured to acquire a real time image of the surrounding region of the automatic door,

the identification unit is configured to identify the attribute information, with respect to the real time image,

the passage condition selection unit is configured to select a passage condition associated with attribute information in the storage unit that has matched the identified attribute information, and

the output unit is configured to output the selected passage condition.

### (Supplementary Note 2)

The passage assistance apparatus according to Supplementary Note 1,

wherein the image acquisition unit is configured to acquire a plurality of real time images over time.

### (Supplementary Note 3)

The passage assistance apparatus according to Supplementary Note 1 or 2,

wherein the attribute information includes information regarding an attribute of a moving object in an image.

### (Supplementary Note 4)

The passage assistance apparatus according to any one of Supplementary Notes 1 to 3,

wherein the attribute information includes movement information that includes at least one of the movement speed of a moving object in an image and vector information regarding the moving object.

### (Supplementary Note 5)

The passage assistance apparatus according to Supplementary Note 4, further comprising

a specific motion detection unit,

wherein the storage unit is configured to further store specific motion information regarding a specific motion of the moving object and region information,

the specific motion information is associated with the passage condition, and

the region information is information regarding a given region from the automatic door, and includes control region information regarding a control region set in the region,

the identification unit is configured to identify the attribute information that includes the moving object movement information, with respect to the real time image,

the specific motion detection unit is configured to detects the specific motion of the moving object using the control region information and the identified attribute information, and

the passage condition selection unit is configured to select a passage condition associated with specific motion information in the storage unit that has matched the detected specific motion.

### (Supplementary Note 6)

The passage assistance apparatus according to Supplementary Note 5,

wherein the specific motion information in the storage unit includes information regarding a rushing motion, and

the specific motion detection unit is configured to detect the motion of the moving object as the “rushing motion”, if the movement speed of the moving object entering the control region is higher than or equal to a preset speed, and the moving object vector information indicates that the moving object moves in a direction toward the automatic door.

### (Supplementary Note 7)

The passage assistance apparatus according to Supplementary Note 5 or 6,

wherein the specific motion information in the storage unit includes information regarding a passing-by motion, and

the specific motion detection unit is configured to detect the motion of the moving object as the “passing-by motion”, if a boundary line of the control region and the moving object vector information intersect at two points.

### (Supplementary Note 8)

The passage assistance apparatus according to any one of Supplementary Notes 5 to 7,

wherein the identification unit is configured to detect the specific motion and identify the attribute information that includes the moving object movement information, with respect to the real time image,

the specific motion detection unit is configured to detect at least either end or continuation of the specific motion of the moving object, based on the moving object movement information identified after the specific motion has been detected, and

the passage condition selection unit is configured to select a passage condition associated with at least one of the attribute information in the storage unit that has matched the identified attribute information, and the specific motion information regarding a specific motion of another moving object other than the specific motion whose end has been detected.

### (Supplementary Note 9)

The passage assistance apparatus according to any one of Supplementary Notes 5 to 8, further comprising:

a sensor data acquisition unit; and

a switching unit,

wherein, in the storage unit, a passage condition regarding passage through the automatic door is associated with information regarding an attribute of an image of a surrounding region of the automatic door and sensor data attribute information regarding a surrounding region of the automatic door in the passage assistance information,

the sensor data acquisition unit is configured to acquire sensor data,

the sensor data is data acquired by a sensor device attached to the automatic door,

the image acquisition unit is configured to acquire a real time image of a surrounding region of the automatic door,

the identification unit is configured to
identify the image attribute information that includes the moving object movement information, with respect to the real time image, and
identify the sensor data attribute information, with respect to the sensor data,

the specific motion detection unit is configured to detect a specific motion of the moving object using the control region information and the identified attribute information, the passage condition selection unit further includes a sensor data open/close control unit and an image analysis open/close control unit,

the switching unit is configured to execute switching between automatic door open/close control that is performed by the sensor data open/close control unit based on sensor data and automatic door open/close control that is performed by the image analysis open/close control unit based on the real time image, depending on whether or not the specific motion has been detected,

the sensor data open/close control unit is configured to select a passage condition associated with sensor data attribute information in the storage unit that has matched the identified sensor data attribute information,

the image analysis open/close control unit is configured to, if the specific motion has been detected, select a passage condition associated with specific motion information in the storage unit that has matched the detected specific motion, and

the output unit is configured to output the selected passage condition.

### (Supplementary Note 10)

The passage assistance apparatus according to Supplementary Note 9,

wherein the identification unit is configured to detect the specific motion and identify the attribute information that includes the moving object movement information, with respect to the real time image,

the specific motion detection unit is configured to detect at least either end or continuation of the specific motion of the moving object, based on the moving object movement information identified after the specific motion has been detected,

the switching unit is configured to execute switching between automatic door open/close control that is performed by the sensor data open/close control unit based on sensor data and automatic door open/close control that is performed by the image analysis open/close control unit based on the real time image, depending on a result of detection of at least either end or continuation of the specific motion,

the sensor data open/close control unit is configured to, if the end of the specific motion has been detected, select a passage condition associated with sensor data attribute information in the storage unit that has matched the identified sensor data attribute information, and

the image analysis open/close control unit is configured to, if the continuation of the specific motion has been detected, select a passage condition associated with specific motion information in the storage unit that has matched the detected specific motion.

### (Supplementary Note 11)

The passage assistance apparatus according to any one of Supplementary Notes 1 to 10,

wherein the attribute information in the storage unit includes a past image.

### (Supplementary Note 12)

The passage assistance apparatus according to any one of Supplementary Notes 1 to 11,

wherein the automatic door opening/closing condition is at least one selected from the group consisting of opening of the automatic door, closing of the automatic door, opening timing, closing timing, opening speed, closing speed, opening holding time, and opening width.

### (Supplementary Note 13)

The passage assistance apparatus according to any one of Supplementary Notes 1 to 12,

wherein the passage guide condition includes an announcement content for a user.

### (Supplementary Note 14)

The passage assistance apparatus according to any one of Supplementary Notes 1 to 13,

wherein the passage guide condition is at least one of sound information and visual information.

### (Supplementary Note 15)

An automatic door passage assistance method comprising:

an image acquisition step;

an identification step;

a passage condition selection step; and

an output step,

wherein passage assistance information regarding passage through an automatic door stored in a storage unit is used,

a passage condition regarding passage through the automatic door and information regarding an attribute of an image of a surrounding region of the automatic door are associated with each other in the passage assistance information,

the passage condition is at least one of an automatic door opening/closing condition and a passage guide condition for an automatic door user,

in the image acquisition step, a real time image of a surrounding region of the automatic door is acquired,

in the identification step, the attribute information is identified, with respect to the real time image;

in the passage condition selection step, a passage condition associated with attribute information in the storage unit that has matched the identified attribute information is selected; and

in the output step, the selected passage condition is output.

### (Supplementary Note 16)

The passage assistance method according to Supplementary Note 15,

in the image acquisition step, a plurality of real time images over time are acquired.

### (Supplementary Note 17)

The passage assistance method according to Supplementary Note 15 or 16,

wherein the attribute information includes information regarding an attribute of a moving object in an image.

### (Supplementary Note 18)

The passage assistance method according to any one of Supplementary Notes 15 to 17,

wherein the attribute information includes movement information that includes at least one of the movement speed of a moving object in an image and vector information regarding the moving object.

### (Supplementary Note 19)

The passage assistance method according to any one of Supplementary Notes 15 to 18, further comprising

a specific motion detection step,

wherein specific motion information regarding a specific motion of a moving object stored in the storage unit and region information are used,

the specific motion information is associated with the passage condition,

the region information is information regarding a given region from the automatic door, and includes control region information regarding a control region set in the region,

in the identification step, the attribute information that includes the moving object movement information is identified, with respect to the real time image,

in the specific motion detection step, a specific motion of the moving object is specified using the control region information and the identified attribute information, and

in the passage condition selection step, a passage condition associated with specific motion information in the storage unit that has matched the detected specific motion is selected.

### (Supplementary Note 20)

The passage assistance method according to Supplementary Note 19,

wherein the specific motion information in the storage unit includes information regarding a rushing motion, and

in the specific motion detection step, the motion of the moving object is detected as the “rushing motion”, if the movement speed of the moving object entering the control region is higher than or equal to a preset speed, and the moving object vector information indicates that the moving object moves in a direction toward the automatic door.

### (Supplementary Note 21)

The passage assistance method according to Supplementary Note 19 or 20,

wherein the specific motion information in the storage unit includes information regarding a passing-by motion, and

in the specific motion detection step, the motion of the moving object is detected as the “passing-by motion”, if a boundary line of the control region and the moving object vector information intersect at two points.

### (Supplementary Note 22)

The passage assistance method according to any one of Supplementary Notes 19 to 21,

wherein, in the identification step, the specific motion is detected and the attribute information that includes the moving object movement information is identified, with respect to the real time image,

in the specific motion detection step, at least either end or continuation of the specific motion of the moving object is detected based on the moving object movement information identified after the specific motion has been detected, and

in the passage condition selection step, a passage condition associated with at least one of the attribute information in the storage unit that has matched the identified attribute information, and the specific motion information regarding a specific motion of another moving object other than the specific motion whose end has been detected is selected.
(Supplementary Note 23)
   The passage assistance method according to any one of Supplementary Notes 19 to 22, further comprising

a sensor data acquisition step; and

a switching step,

wherein a passage condition regarding passage through the automatic door is associated with information regarding an attribute of an image of a surrounding region of the automatic door and sensor data attribute information regarding a surrounding region of the automatic door in the passage assistance information stored in the storage unit,

in the sensor data acquisition step,
sensor data is acquired, and
the sensor data is data acquired by a sensor device attached to the automatic door,

in image acquisition step, a real time image of a surrounding region of the automatic door is acquired,

in the identification step, the image attribute information that includes the moving object movement information is identified, with respect to the real time image, and

the sensor data attribute information is identified, with respect to the sensor data,

in the specific motion detection step, a specific motion of the moving object is specified using the control region information and the identified attribute information,

the passage condition selection step further includes a sensor data open/close control step and an image analysis open/close control step,

in the switching step, depending on whether or not the specific motion has been detected, switching is executed between automatic door open/close control that is performed in the sensor data open/close control step based on sensor data and automatic door open/close control that is performed in the image analysis open/close control step based on the real time image,

in the sensor data open/close control step, a passage condition associated with sensor data attribute information in the storage unit that has matched the identified sensor data attribute information is selected,

in the image analysis open/close control step, if the specific motion has been detected, a passage condition associated with specific motion information in the storage unit that has matched the detected specific motion is selected, and

in the output step, the selected passage condition is output.

### (Supplementary Note 24)

The passage assistance method according to Supplementary Note 23,

wherein, in the identification step, the specific motion is detected and the attribute information that includes the moving object movement information is identified, with respect to the real time image,

in the specific motion detection step, at least either end or continuation of the specific motion of the moving object is detected based on the moving object movement information identified after the specific motion has been detected,

in the switching step, depending on a result of detection of at least either end or continuation of the specific motion, switching is executed between automatic door open/close control that is performed in the sensor data open/close control step based on sensor data and automatic door open/close control that is performed in the image analysis open/close control step based on the real time image,

in the sensor data open/close control step, if the end of the specific motion has been detected, a passage condition associated with sensor data attribute information in the storage unit that has matched the identified sensor data attribute information is selected, and

in the image analysis open/close control step, if the continuation of the specific motion has been detected, a passage condition associated with specific motion information in the storage unit that has matched the detected specific motion is selected.

### (Supplementary Note 25)

The passage assistance method according to any one of Supplementary Notes 15 to 24,

wherein the attribute information in the storage unit includes a past image.

### (Supplementary Note 26)

The passage assistance method according to any one of Supplementary Notes 15 to 25,

wherein the automatic door opening/closing condition is at least one selected from the group consisting of opening of the automatic door, closing of the automatic door, opening timing, closing timing, opening speed, closing speed, opening holding time, and opening width.

### (Supplementary Note 27)

The passage assistance method according to any one of Supplementary Notes 15 to 26,

wherein the passage guide condition includes an announcement content for a user.

### (Supplementary Note 28)

The passage assistance method according to any one of Supplementary Notes 15 to 27,

wherein the passage guide condition is at least one of sound information and visual information.

### (Supplementary Note 29)

A program for causing a computer to execute a procedure that includes an image acquisition procedure, an identification procedure, a passage condition selection procedure, and an output procedure,

wherein passage assistance information regarding passage through an automatic door stored in a storage unit is used,

a passage condition regarding passage through the automatic door is associated with information regarding an attribute of an image of a surrounding region of the automatic door in the passage assistance information,

the passage condition is at least one of an automatic door opening/closing condition and a passage guide condition for an automatic door user,

in the image acquisition procedure, a real time image of a surrounding region of the automatic door is acquired,

in the identification procedure, the attribute information is identified, with respect to the real time image,

in the passage condition selection procedure, a passage condition associated with attribute information in the storage unit that has matched the identified attribute information is selected, and

in the output procedure, the selected passage condition is output.

### (Supplementary Note 30)

The program according to Supplementary Note 29,

wherein in the image acquisition procedure, a plurality of real time images over time are acquired.

### (Supplementary Note 31)

The program according to Supplementary Note 29 or 30,

wherein the attribute information includes information regarding an attribute of a moving object in an image.

### (Supplementary Note 32)

The program according to any one of Supplementary Notes 29 to 31,

wherein the attribute information includes movement information that includes at least one of the movement speed of a moving object in an image and vector information regarding the moving object.

### (Supplementary Note 33)

The program according to any one of Supplementary Notes 29 to 32, further comprising

a specific motion detection procedure,

wherein specific motion information regarding a specific motion of a moving object stored in the storage unit and region information are used,

the specific motion information is associated with the passage condition,

the region information is information regarding a given region from the automatic door, and includes control region information regarding a control region set in the region,

in the identification procedure, the attribute information that includes the moving object movement information is identified, with respect to the real time image,

in the specific motion detection procedure, a specific motion of the moving object is detected using the control region information and the identified attribute information, and

in the passage condition selection procedure, a passage condition associated with specific motion information in the storage unit that has matched the detected specific motion is selected.

### (Supplementary Note 34)

The program according to Supplementary Note 33,

wherein the specific motion information in the storage unit includes information regarding a rushing motion, and

in the specific motion detection procedure, the motion of the moving object is detected as the “rushing motion”, if the movement speed of the moving object entering the control region is higher than or equal to a preset speed, and the moving object vector information indicates that the moving object moves in a direction toward the automatic door.

### (Supplementary Note 35)

The program according to Supplementary Note 33 or 34,

wherein the specific motion information in the storage unit includes information regarding a passing-by motion, and

in the specific motion detection procedure, the motion of the moving object is detected as the “passing-by motion”, if a boundary line of the control region and the moving object vector information intersect at two points.

### (Supplementary Note 36)

The program according to any one of Supplementary Notes 33 to 35,

wherein, in the identification procedure, the specific motion is detected and the attribute information that includes the moving object movement information is identified, with respect to the real time image,

in the specific motion detection procedure, at least either end or continuation of the specific motion of the moving object is detected based on the moving object movement information identified after the specific motion has been detected, and

in the passage condition selection procedure, a passage condition associated with at least one of the attribute information in the storage unit that has matched the identified attribute information, and the specific motion information regarding a specific motion of another moving object other than the specific motion whose end has been detected is selected.

### (Supplementary Note 37)

The program according to any one of Supplementary Notes 33 to 36, further comprising:

a sensor data acquisition procedure and a switching procedure,

wherein a passage condition regarding passage through the automatic door is associated with information regarding an attribute of an image of a surrounding region of the automatic door and sensor data attribute information regarding a surrounding region of the automatic door in the passage assistance information stored in the storage unit,

in the sensor data acquisition procedure,
sensor data is acquired, and
the sensor data is data acquired by a sensor device attached to the automatic door,

in the image acquisition procedure, a real time image of a surrounding region of the automatic door is acquired,

in the identification procedure,
the image attribute information that includes the moving object movement information is identified, with respect to the real time image, and
the sensor data attribute information is identified, with respect to the sensor data,

in the specific motion detection procedure, a specific motion of the moving object is detected using the control region information and the identified attribute information,

the passage condition selection procedure further includes a sensor data open/close control procedure and an image analysis open/close control procedure,

in the switching procedure, depending on whether or not the specific motion has been detected, switching is executed between automatic door open/close control that is performed in the sensor data open/close control procedure based on sensor data and automatic door open/close control that is performed in the image analysis open/close control procedure based on the real time image,

in the sensor data open/close control procedure, a passage condition associated with sensor data attribute information in the storage unit that has matched the identified sensor data attribute information is selected,

in the image analysis open/close control procedure, if the specific motion has been detected, a passage condition associated with specific motion information in the storage unit that has matched the detected specific motion is selected, and

in the output procedure, the selected passage condition is output.

### (Supplementary Note 38)

The program according to Supplementary Note 37,

wherein, in the identification procedure, the specific motion is detected and the attribute information that includes the moving object movement information is identified, with respect to the real time image,

in the specific motion detection procedure, at least either end or continuation of the specific motion of the moving object is detected based on the moving object movement information identified after the specific motion has been detected,

in the switching procedure, depending on a result of detection of at least either end or continuation of the specific motion, switching is executed between automatic door open/close control that is performed in the sensor data open/close control procedure based on sensor data and automatic door open/close control that is performed in the image analysis open/close control procedure based on the real time image,

in the sensor data open/close control procedure, if the end of the specific motion has been detected, a passage condition associated with sensor data attribute information in the storage unit that has matched the identified sensor data attribute information is selected, and

in the image analysis open/close control procedure, if the continuance of the specific motion has been detected, a passage condition associated with specific motion information in the storage unit that has matched the detected specific motion is selected.

### (Supplementary Note 39)

The program according to any one of Supplementary Notes 29 to 38,

wherein the attribute information in the storage unit includes a past image.

### (Supplementary Note 40)

The program according to any one of Supplementary Notes 29 to 39,

wherein the automatic door opening/closing condition is at least one selected from the group consisting of opening of the automatic door, closing of the automatic door, opening timing, closing timing, opening speed, closing speed, opening holding time, and opening width.

### (Supplementary Note 41)

The program according to any one of Supplementary Notes 29 to 40,

wherein the passage guide condition includes an announcement content for a user.

### (Supplementary Note 42)

The program according to any one of Supplementary Notes 29 to 41,

wherein the passage guide condition is at least one of sound information and visual information.

### (Supplementary Note 43)

A computer readable recording medium on which the program according any one of Supplementary Notes 29 to 42 is recorded.

### INDUSTRIAL APPLICABILITY

According to the present invention, it is possible to control opening/closing of an automatic door and output guide conditions for a user, using images of a surrounding region of the automatic door, according to the user of the automatic door and the condition of the surrounding region of the automatic door, for example. Accordingly, it is possible to ensure the safety of passing persons and allow smooth passage while suppressing the occurrence of waiting time, congestion, and the like when passing through the automatic door, for example.

### REFERENCE SIGNS LIST

1 Passage assistance apparatus

10 Storage unit

11 Image acquisition unit

12 Identification unit

13 Passage condition selection unit

14 Output unit

15 Passage assistance information

16 Specific motion detection unit

17 Sensor data acquisition unit

18 Switching unit

31 Camera

32 Automatic door

33 Display unit

34 Speaker

2 Communication network

1. An apparatus for automatic door passage assistance comprising at least one processor configured to:
store passage assistance information regarding passage through an automatic door,
a passage condition regarding passage through the automatic door and information regarding an attribute of an image of a surrounding region of the automatic door being associated with each other in the passage assistance information,
the passage condition being at least one of an automatic door opening/closing condition and a passage guide condition for an automatic door user;
acquire a real time image of the surrounding region of the automatic door;
identify the attribute information, with respect to the real time image;
select a passage condition associated with attribute information in the storage unit that has matched the identified attribute information; and
output the selected passage condition.

2. The apparatus according to claim 1, wherein the processor is configured to:
acquire a plurality of real time images over time.

3. The apparatus according to claim 1, wherein
the attribute information includes information regarding an attribute of a moving object in an image.

4. The apparatus according to claim 1, wherein
the attribute information includes movement information that includes at least one of the movement speed of a moving object in an image and vector information regarding the moving object.

5. The apparatus according to claim 4, wherein the processor is configured to:
store specific motion information regarding a specific motion of the moving object and region information,
the specific motion information being associated with the passage condition, and
the region information being information regarding a given region from the automatic door, and includes control region information regarding a control region set in the region;
identify the attribute information that includes the moving object movement information, with respect to the real time image;
detect the specific motion of the moving object using the control region information and the identified attribute information; and
select a passage condition associated with specific motion information in the storage unit that has matched the detected specific motion.

6. The apparatus according to claim 5, wherein
the specific motion information stored includes information regarding a rushing motion, and
the processor is configured to:
detect the motion of the moving object as the “rushing motion”, if the movement speed of the moving object entering the control region is higher than or equal to a preset speed, and the moving object vector information indicates that the moving object moves in a direction toward the automatic door.

7. The apparatus according to claim 5, wherein
the specific motion information stored includes information regarding a passing-by motion, and
the processor is configured to:
detect the motion of the moving object as the “passing-by motion”, if a boundary line of the control region and the moving object vector information intersect at two points.

8. The apparatus according to claim 5, wherein the processor is configured to:
detect the specific motion and identify the attribute information that includes the moving object movement information, with respect to the real time image;
detect at least either end or continuation of the specific motion of the moving object, based on the moving object movement information identified after the specific motion has been detected; and
select a passage condition associated with at least one of the attribute information stored that has matched the identified attribute information, and the specific motion information regarding a specific motion of another moving object other than the specific motion whose end has been detected.

9. The apparatus according to claim 5 wherein
a passage condition regarding passage through the automatic door is associated with information regarding an attribute of an image of a surrounding region of the automatic door and sensor data attribute information regarding a surrounding region of the automatic door in the passage assistance information,
the processor is configured to:
acquire sensor data;
the sensor data being data acquired by a sensor device attached to the automatic door;
acquire a real time image of a surrounding region of the automatic door;
identify the image attribute information that includes the moving object movement information, with respect to the real time image; and
identify the sensor data attribute information, with respect to the sensor data,
detect a specific motion of the moving object using the control region information and the identified attribute information;
execute switching between automatic door open/close control that is performed based on sensor data and automatic door open/close control that is performed based on the real time image, depending on whether or not the specific motion has been detected;
select a passage condition associated with sensor data attribute information stored that has matched the identified sensor data attribute information;
if the specific motion has been detected, select a passage condition associated with specific motion information stored that has matched the detected specific motion; and
output the selected passage condition.

10. The apparatus according to claim 9, wherein the processor is configured to:
detect the specific motion and identify the attribute information that includes the moving object movement information, with respect to the real time image;
detect at least either end or continuation of the specific motion of the moving object, based on the moving object movement information identified after the specific motion has been detected;
execute switching between automatic door open/close control that is performed based on sensor data and automatic door open/close control that is performed based on the real time image, depending on a result of detection of at least either end or continuation of the specific motion;
if the end of the specific motion has been detected, select a passage condition associated with sensor data attribute information stored that has matched the identified sensor data attribute information; and
if the continuation of the specific motion has been detected, select a passage condition associated with specific motion information stored that has matched the detected specific motion.

11. The apparatus according to claim 1, wherein
the attribute information stored includes a past image.

12. The apparatus according to claim 1, wherein
the automatic door opening/closing condition is at least one selected from the group consisting of opening of the automatic door, closing of the automatic door, opening timing, closing timing, opening speed, closing speed, opening holding time, and opening width.

13. The apparatus according to claim 1, wherein
the passage guide condition includes an announcement content for a user.

14. The apparatus according to claim 1, wherein
the passage guide condition is at least one of sound information and visual information.

15. A computer-implemented method for an automatic door passage assistance, wherein
passage assistance information regarding passage through an automatic door stored is used,
a passage condition regarding passage through the automatic door and information regarding an attribute of an image of a surrounding region of the automatic door are associated with each other in the passage assistance information,
the passage condition is at least one of an automatic door opening/closing condition and a passage guide condition for an automatic door user, and
the method comprises:
acquiring a real time image of a surrounding region of the automatic door;
identifying the attribute information, with respect to the real time image;
selecting a passage condition associated with attribute information stored that has matched the identified attribute information; and
outputting the selected passage condition.

16. The method according to claim 15, comprising:
acquiring a plurality of real time images over time.

17. The method according to claim 15, wherein
the attribute information includes information regarding an attribute of a moving object in an image.

18. The method according to claim 15, wherein
the attribute information includes movement information that includes at least one of the movement speed of a moving object in an image and vector information regarding the moving object.

19. The method according to claim 15, wherein
specific motion information regarding a specific motion of a moving object stored and region information are used,
the specific motion information is associated with the passage condition,
the region information is information regarding a given region from the automatic door, and includes control region information regarding a control region set in the region,
in the identification step, the attribute information that includes the moving object movement information is identified, with respect to the real time image, and
the method comprises:
specifying a specific motion of the moving object using the control region information and the identified attribute information; and
selecting a passage condition associated with specific motion information that has matched the detected specific motion.

20.-42. (canceled)

43. A non-transitory computer readable recording medium on which a program is recorded, wherein
the program causes a computer to execute a method for automatic door passage assistance,
passage assistance information regarding passage through an automatic door stored is used,
a passage condition regarding passage through the automatic door and information regarding an attribute of an image of a surrounding region of the automatic door are associated with each other in the passage assistance information,
the passage condition is at least one of an automatic door opening/closing condition and a passage guide condition for an automatic door user, and
the method comprises:
acquiring a real time image of a surrounding region of the automatic door;
identifying the attribute information, with respect to the real time image;
selecting a passage condition associated with attribute information stored that has matched the identified attribute information; and
outputting the selected passage condition.
